(19) United States
(12) Patent Application Publication
(10) Pub. No.: US 2011/0276393 A1
(43) Pub. Date: Nov. 10, 2011

(54) Pay-Per-Sale ad system

(76) Inventors: Thirunarayanan Srinivasan, Highlands Ranch, CO (US); Ramesh Ramamurthy, Highlands Ranch, CO (US); Krishnan Kannan, Englewood, CO (US); Gopakumar Padmanabhan, Highlands Ranch, CO (US)

(21) Appl. No.: 12/773,108

(22) Filed: May 4, 2010

(51) Int. Cl. G06Q 30/00; G06F 17/30; G06Q 40/00

(52) U.S. Cl. 705/14.46; 707/769; 707/802; 707/E17.005; 707/E17.014

(57) ABSTRACT

A method and system are provided for connecting consumer searches and in-store transactions using credit cards, debit cards, and gift cards. In accordance with one or more embodiments, the method includes the steps of (a) receiving from a search system and storing the search results relating to an online or mobile search performed by a consumer, the search results identifying one or more telephone numbers of merchants that signed up with the search system as Advertisers, and the search association identifiers such as IP Address, Cookie, and/or Carrier User ID associated with the consumer; (b) associating the card to the online or mobile search by matching the search association identifiers based on two purchase transactions originated from the same card number within a predetermined period of time of the one or more searches; (c) charging the selected Advertiser a fee for successful correlation of the consumer's transaction to the search association identifiers; and (d) providing detailed Return-On-Investment reports.

### RELATED APPLICATIONS

The present application is related to United States patent number The pending U.S. patent application Ser. No. 12/728,311 from Thirunarayanan Srinivasan et. al., issued Mar. 22, 2010, by Thirunarayanan Srinivasan, Ramesh Ramamurthy, Kannan Krishnan, Murali Anakavur, and Gopakumar Padmanabhan, included by reference herein.

### FIELD OF THE INVENTION

The present invention relates to a pay-per-sale solution and, more particularly, to associating the online and mobile searches and physical store transactions automatically and in an anonymous manner.

### BACKGROUND OF THE INVENTION

Stores promote products and services many different ways. They run advertisements in newspapers, electronic media, weekly circulars as part of stand-in newspaper inserts, Internet, mobile, and direct mail. The promotions may or may not contain a discount and may or may not require the user to produce a coupon to enjoy the benefits of the promotional offer.

Many applications exist today that deliver coupons to users upon request. However, each method has one or more drawbacks. For example, there are methods that require users to register with details of name, address, email address, and/or phone number. Other methods may require the users to carry a loyalty card in their wallets or keychains. Yet another method may involve sending direct mail offers in the form of Val-Pak type of coupons that may not be redemeed at all.

In a direct mail coupon system, the publisher charges the Advertiser for a bulk number of coupons printed and delivered to the users. Moreover, the said user can freely pass the coupon to his friends and colleagues at work for redemption. Thus, the Advertiser does not know for a fact that the redeeming user obtained the coupon as a result of a targeted mail delivery vs. through his friends and co-workers. In a targeted direct mail, the publisher knows the address of the recipients. In addition, the publisher can aid the Advertiser to easily keep track of the user's purchase patterns by printing unique coupon codes for the store per recipient.

In a digital mobile coupon system, a lead is raised when a coupon is delivered to the user upon request via either the web page or phone call. The said coupon could be found as a result of a search by the user. Moreover, the said user can freely pass the coupon to his friends and colleagues at work for redemption. Thus, the Advertiser does not know for a fact that the redeeming user obtained the coupon as a result of a search vs. through his friends and co-workers. The phone number of the recipients of the coupon is known to the Advertiser and so the users are not anonymous.

Alternatively, the user can search the website of an Advertiser and then assign coupons of interest to a loyalty card. However, the difficulty lies in the fact that every store must offer a loyalty card and operate the associated IT infrastructure, which means a huge expense to the Advertiser. In addition, there is certain amount of sacrifice on the part of the users when it comes to their privacy because the store knows the personal details of the cardholders and can keep track of the users' purchase behavior.

In yet another method, the store can conduct surveys as to how the user ends up buying a particular product. However, surveys are inherently flawed for the reason that the user's answers may not be correct or misleading.

In yet another method employed by a company called CaliberData, Inc. (http://www.caliberdata.com), the system requires credit and debit cardholders to register their card numbers at their website for cashback, then conduct the search prior to the in-store purchase using the same card. The problem with the model is that most cardholders would not register their card numbers just for earning cashback not to mention the fact that personal information is divulged to the system. In addition, the Processor that handles the merchant's account may not want to share the sale amount charged to the card, as that could be considered a violation of its policy agreed with the merchant. This problem also extends to Card Brands such as VISA, MasterCard, and Amex in that sharing of sale amounts will be an obstacle for CaliberData's business model because the amount is what decides the cashback amount credited to the cardholder's account registered with the CaliberData system.

In all the above methods, there is no proof that associates the user's search activity that displayed the promotion offer either online or mobile to the physical store purchase made by the same user in an anonymous manner.

United States Patent Application 20080281702 describes a system and method for providing mobile coupon information in a network.

U.S. Pat. No. 5,380,991 describes a system and method for a paperless coupon redemption that is based on a smart card.

United States Patent Application 20100010889 describes a system and method for a multiple merchant stored value card.

U.S. Pat. No. 9,468,698 describes a coupon delivery system.

CaliberData. Inc. (http://www.caliberdata.com) has a pending patent application for its business model.

Existing applications for which either patents have been issued or pending are based on coupons. However, a user may not be enticed to enter a physical store solely based on a coupon offer that requires the user to produce a currency in the form of a mobile or printed coupon to avail the discount. The offer could be a simple promotion that does not require a coupon to be produced. Moreover, the existing applications do not offer proof of a user's conversion through a purchase at a physical store that is linked to an online or mobile search activity that displayed the promotion to the user would be advantageous to provide proof that each ad impression can result in no more than one chargeable lead.

It would be advantageous to charge the lowest bid amount for all the ads viewed through a search prior to the in-store shopping using a credit, debit, or gift card because the system cannot attribute the transaction to specific products/services and quantity of each of the products/services bought. However, the intent of the user to find out the promotions through searches serves as a motivation for the same user to visit the physical stores in the neighborhood to complete the purchase for which the system attempts to take credit in the form of the lowest bid amount of one of the groups of possible products/services bought. This way, the method does not violate the privacy policies of the parties, namely, the user, Search Engine, and Card Brand, involved.

It would also be advantageous to provide proof of consumer's search that led to the physical store purchase.

It would further be advantageous to provide a detailed ROI report.

### SUMMARY OF THE INVENTION

A method and system are provided for connecting consumer searches and physical store purchases using a credit card, debit card, and gift card in an anonymous manner. In accordance with one or more embodiments, the method includes the steps of (a) receiving from a search system and storing the search results relating to an online or mobile search performed by a consumer, the search results identifying one or more telephone numbers of merchants that signed up with the search system as Advertisers, and the search association identifiers such as IP Address, Cookie, and/or Carrier User ID associated with the consumer; (b) associating the Card Number to the online or mobile search by matching the search association identifiers based on two card transactions originated from the same Card Number within a predetermined period of time of the one or more searches performed by the consumer; (c) charging the selected Advertiser a fee for the store purchase made by the consumer to the Advertiser based on the lowest bid amount of a group of ads viewed without attribution to quantity of products purchased; and (d) providing detailed Return-On-Investment reports to the Advertiser, search system, and card brand.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a pay-per-sale ad system receiving and storing search results containing advertisers;

FIG. 2 is a perspective view of a pay-per-sale ad system associating in-store purchase transaction to search;

FIG. 3A is an exploded view of a pay-per-sale ad system storing the data in lh merchant db tables;

FIG. 4 is an exploded view of a pay-per-sale ad system of storing the data in lh tdr server tables;

FIG. 5A is an exploded view of a pay-per-sale ad system executing the correlation logic;

FIG. 5B is an exploded view of a pay-per-sale ad system executing the correlation logic;

FIG. 5C is an exploded view of a pay-per-sale ad system executing the correlation logic;

FIG. 5D is an exploded view of a pay-per-sale ad system executing the correlation logic;

FIG. 6 is an exploded view of a pay-per-sale ad system to allow viewing of roi reports by the advertiser; and

FIG. 7 is an exploded view of an example for calculating the minimum bid amount for a group of ads by the ads server based on one or more groups of ads viewed.

For purposes of clarity and brevity, like elements and components will bear the same designations and numbering throughout the Figures.

### DESCRIPTION OF THE PREFERRED EMBODIMENT

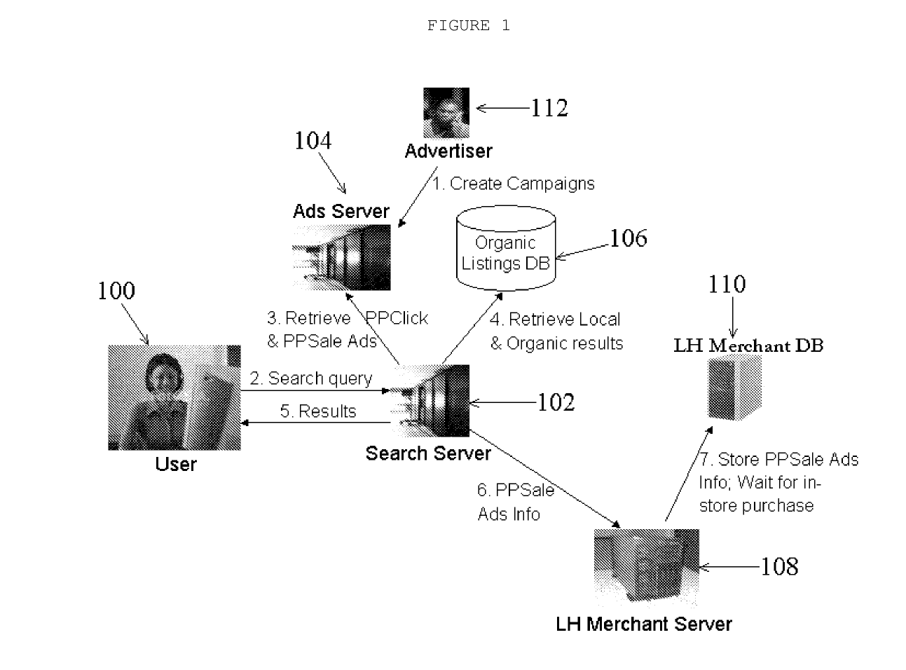

FIG. 1 is a perspective view of receiving and storing search results, in accordance with the invention. An Advertiser 112 creates an account and one or more PPSale campaigns for one or more products/services in the Search Server 102. The Advertiser 112 specifies the applicable price for the product/service for which the ad is created. Ads Server 104 shall have a product/service catalog loaded as reference data. Each product/service shall have minimum and maximum price values defined. When a price is specified for a product/service, the Ads Server 104 verifies if the price is between the minimum and maximum values. If not, an error message will be displayed to allow the Advertiser 112 to enter a new value. However, only the maximum value will be displayed to the Advertiser 112 because if the Ads Server 104 displayed the minimum value, then Advertiser 112 may not enter the true value of the product/service but will choose the minimum value only so as to cause revenue leakage for all the parties, namely, Search Engine (SE), Card Brand (such as VISA, MasterCard, Amex), and LeadHancer (LH). The Ads Server 104 consists of one or more computers interconnected in a data center(s) and hosted either inside or outside the firewall of the search system or a 3rd party vendor.

For each PPSale Advertiser 112 signed up, Ads Server 104 sends information such as advertiser_name, DN, mid, se_id, tax_rate, address, city, state, and zip_code. LH Merchant Server 108 creates a record in the PPSale_Advertisers 300 table and sets the status of the Advertiser 112 to Active. LH Merchant Server 108 also sends the Advertiser 112 details to one or more Card Brands running the Card Server 202, which stores the values in its database. Card Server 202 in turn sends the mid and DN to LH TDR Server 204, which in turn stores them in the PPSale_DNs 400 table. Card Server 202 processes Auth and Void transactions only for the mid values that have signed up for PPSale Ads in one or more Search Engines. Card Server 202 also forwards the se_id, mid, and DN to the LH TDR Server 204, which in turn saves the values by creating a record in the PPSale_DNs 400 table. Moreover, as each PPSale Ad campaign is created, the Ads Server 104 sends the data related to the ad to LH Merchant Server 108 for storage in the PPSale_Ads 316 table. The data received include: se_id, DN, ad_id, product_name, product_price, and promo_end_time. It is a requirement that all PPSale Ads for a given store location will expire at the same time. However, the Advertiser 112 also can specify an automatic extension of each of the ads until a final date/time, at which time the ad will cease to exist. LH Merchant Server 108 computes the product_price_after_tax, min_product_price_after_tax, and max_product_price_after_tax. The product_price_after_tax value is based on the applicable tax_rate for the Advertiser 112. The other two values, namely, min_product_price_after_tax and max_product_price_after_tax, could be the price range that the user 100 could have shopped in-store for a comparable product/service. The values are determined based on pre-determined percentages that represent the lower and upper ends of the product_price.

In another embodiment of the invention, if the mid of the Advertiser 112 is considered to be a sensitive information, then the Search Engine can send the mid in both clear-text as well as encrypted directly to one or more Card Brands' Card Server 202 while only sending the encrypted value to LH Merchant Server 108. Each Card Server 202 in turn could send only the encrypted value to its own LH TDR Server 204.

When a PPSale Advertiser 112 ends the campaign in the SE, the Ads Server 104 invokes a Web Service running in the LH Merchant Server 108, which will set the advertiser_status column to Inactive in the PPSale_Advertisers 300 table. In addition, if the Advertiser 112 has ended the campaign with the last Search Engine, then it sends a campaign end message to all the Card Brands' running the Card Server 202 with the parameters of se_id and mid. Upon receipt of the message, the Card Server 202 deletes the mid for PPSale tracking for the given se_id. This means the Card Server 202 will stop sending any more Auth and Void transactions to LH TDR Server 204. Card Server 202 also passes the campaign end notice to LH TDR Server 204.

A user 100 performs either an online or mobile search in a search system comprising a Search Server 102. The Search Server 102 consists of one or more computers interconnected within a data center(s) as in the case of search engines like Google, Microsoft's Bing, and Yahoo!. In the case of mobile searches, the WAP (Wireless Access Protocol) Server hosted by the search system receives the search query and forwards the same to the Search Server 102.

Search Server 102 is attached to an Ads Server 104 that contains both Pay-Per-Sale (PPSale) and Pay-Per-Click (PPClick) ads. Search Server 102 is also attached to an Organic Listings DB that provides search results containing the local and natural listings displayed to the user 100. Based on the search query entered, Search Server 102 displays the search results consisting of relevant ads and natural listings to the user 100. The ads in turn consist of PPSale and/or PPClick Advertisers. Search Server 102 determines the relevant PPSale ads from the Ads Server 104. Such ads selected for display to the user 100 will be associated with a Directory Number (DN), one or more Keywords, and one or more Campaign Names that contain one or more Keywords as configured by the Advertiser 112 with the search system. The Advertiser 112 also specifies the bid amount to be charged for a valid lead delivered in the form of an in-store purchase transaction in the Ads Server 104.

Along with the search query, Search Server 102 also receives the search association identifiers such as IP Address and Cookie for an online search vs. Carrier UserID and Cookie for a mobile search from the user 100. Search Server 102 sends a search results message with parameters such as IP Address/Carrier UserID, Cookie, se_id, search_time, search_type (online or mobile), and one or more Directory Numbers (DNs), an ad_id for respective DNs, Keywords for respective DNs (optional), Campaign Names for respective DNs (optional) of the PPSale ads to LH Merchant Server 108, where “LH” stands for LeadHancer. While the user 100 may block the Cookie through the browser options, Search Server 102 always generates it and passes it to LH Merchant Server 108 even though the Search Server 102 cannot write it to the user's computer or mobile device. For mobile searches, however, the Search Server 102 always receives the Carrier UserID associated with the mobile device, which is a unique value that cannot be blocked by the user 100 because the value is sent by the mobile carrier's WAP Gateway to the WAP Server hosted by the search system. LH Merchant Server 108 stores the parameters received in a table called Search_Records 302 in the LH Merchant DB, provided the DN is present in the PPSale_Advertisers 300 table. Each record in the Search_Records 302 table has a unique index of search_record_id. The Search Server 102 passes the Carrier UserID value in the IP Address field to the LH Merchant Server 108. Therefore, all references to IP Address in the context of mobile searches mean the Carrier UserID. The records in the Search_Records 302 table will be set to expire at search_time+promo_end_time value of each ad viewed, where the promo_end_time value is determined by a look up of the PPSale_Ads 316 table based on the combination of se_id, DN, and ad_id values received in the search results message. A scheduled process running in the LH Merchant Server 108 will purge the expired records from the Search_Records 302 table based on current time.

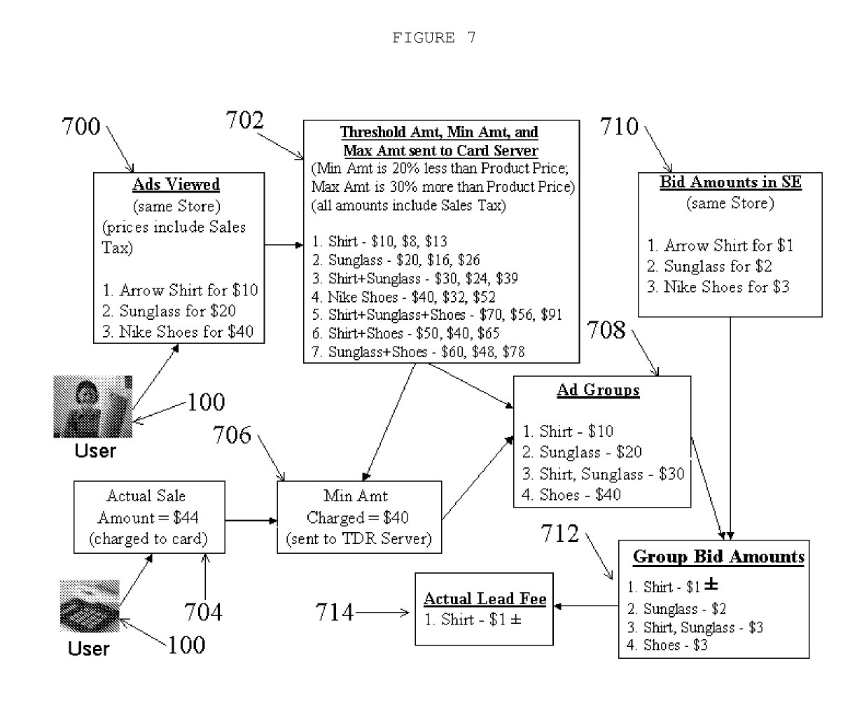

For each record created in the Search_Records 302 table, LH Merchant Server 108 executes the following functionality. FIG. 7 is an exploded view of calculating the min_amount_charged value to be reported by the Card Server 202 to the LH TDR Server 204, in accordance with the invention. Refer to FIG. 7, steps 700 and 702 to understand the following two sections. Step 700 shows the product_price_after_tax of the various ads viewed by the user 100 in the search results. The reason for the min_amt and max_amt mentioned below is that the user 100, while standing in front of the shelf that contains the product of interest could choose to opt for either a lower priced or higher priced product/service of comparable nature than the one h/she actually viewed in the search results prior to the in-store visit. These values are calculated and stored based on certain pre-determined percentages like (20% below the product_price_after_tax and 30% above the product_price_after_tax) off of the product_price_after_tax and are stored in the PPSale_Ads 316 table.

1) As described by step 702, create one or more records in the Threshold_Amounts table with se_id, mid (determined based on se_id+DN received), ad_id, threshold_amt=product_price_after_tax (based on se_id+DN+ad_id received), min_amt=min_product_price_after_tax, max_amt=max_product_price_after_tax, and exp_time=promo_end_time (based on se_id+DN+ad_id received), provided a matching record for all the 5 values (se_id+mid+ad_id+threshold_amt+exp_time) does not already exist. If the record is created and the same combination of mid+threshold_amt does not already exist in another record for a different ad_id, then invoke a web service running in each of the Card Server 202 and send the 5 values of: mid, threshold_amt, min_amt, max_amt, and exp_time. Card Server 202 stores the values in its own table, say, Threshold_Amounts.

2) Also as described by step 702, take the threshold_amt (i.e.=product_price_after_tax) for the ad_id (based on se_id+DN+ad_id received), and add it recursively to the threshold_amt (but not to itself) of the records in the Threshold_Amounts table. For each of the resulting values, create a record in the Threshold_Amounts table with se_id, mid (determined based on se_id+DN received), ad_id=“a#f4gh$%*&̂gh3490v$*@jk4589!” (NOTE: ad_id is hard-coded like this because this is for a Sum of various prices and it could in the rarest of rare circumstances only match a genuine ad_id), threshold_amt=recursive threshold_amt, and exp_time=promo_end_time (based on se_id+DN+ad_id received), provided a matching record for all the 5 values (se_id+mid+ad_id+threshold_amt+exp_time) does not already exist. If the record is created, invoke a web service running in each of the Card Server 202 and send the 5 values of: mid, threshold_amt, min_amt, max_mt, and exp_time. Card Server 202 stores the values in its own Threshold_Amounts table.

In one embodiment of the invention, it is possible that the user 100 may perform a search after deleting the Cookies through the browser options while the IP Address remains the same as the previous search(s). Alternatively, the user 100 may perform a search with a newly assigned IP Address from their ISP (Internet Service Provider) while maintaining the same Cookie as the previous search(s). In both cases, upon receipt of the message containing the search results, LH Merchant Server 108 determines one or more records in the Cards_Learned 308 table that match the said IP Address or said Cookie, as the case maybe, and then creates new records in the Cards_Learned 308 table with the said IP Address and Cookie present in the search results message sent by the Search Server 102, same card_number and brand_id as the present said record of the Cards_Learned 308 table, and time_of_last_transaction equal to said search_time present in the search results message sent by the Search Server 102, provided the record for the combination of Cookie+IP Address+card_number does not already exist in the Cards_Learned 308 table.

In another embodiment of the invention, if there is no change in the IP Address and Cookie, then LH Merchant Server 108 extends the expiration_time of the matching records of the First_Transaction_History 304 table with a value of said search_time present in the search results message sent by the Search Server 102+a predetermined value.

In yet another embodiment of the invention, if there is a change in either the IP Address or Cookie, then LH Merchant Server 108 determines one or more records in the First_Transaction_History 304 table that match the said IP Address or said Cookie and the difference between transaction_time column in the said record and search_time received in the search result is more than a pre-determined time and [(DN in the said record is not equal to one of the DNs received in the search result) or (DN in the record is equal to one of the DNs received in the search result and ad_id in the said record is not equal to the ad_id of the matched DN received in the search result)], as the case maybe, and then creates new records in the First_Transaction_History 304 table with the said IP Address and Cookie present in the search results message sent by the Search Server 102, same DN, card_number, se_id, search_record_id, keywords, campaign_name, search_time, transaction_time, transaction_id, brand_id, charge_flag, ad_id, and min_amt_charged as the present said record of the First_Transaction_History 304 table, and expiration_time equal to said search_time present in the search results message sent by the Search Server 102+a predetermined value. The new records will ensure that the card_number is learned when a second transaction occurs at a physical store as explained in the following sections. The reason for the rigorous check specified in the earlier sentence ensures that the user's card is not learned for making a purchase transaction based on a subsequent search that results in the same physical store and same ad_id, as displayed by the search results presented to the user 100.

LH Merchant Server 108 may be hosted either inside or outside the search system's firewall. For privacy reasons, a search system may pass encrypted values of the IP Address, Cookie/Carrier UserID, Keywords, and Campaign Names to LH Merchant Server 108. LH Merchant Server 108 stores the received parameters in the LH Merchant DB until such time as either the promo_end_time or an in-store purchase transaction is received from the said user 100. LH Merchant Server 108 consists of one or more computers interconnected with a datacenter(s). LH Merchant DB consists of one or more computers interconnected with a datacenter(s) running popular databases like Oracle, My*SQL, or SQL Server and maybe contained in the LH Merchant Server 108.

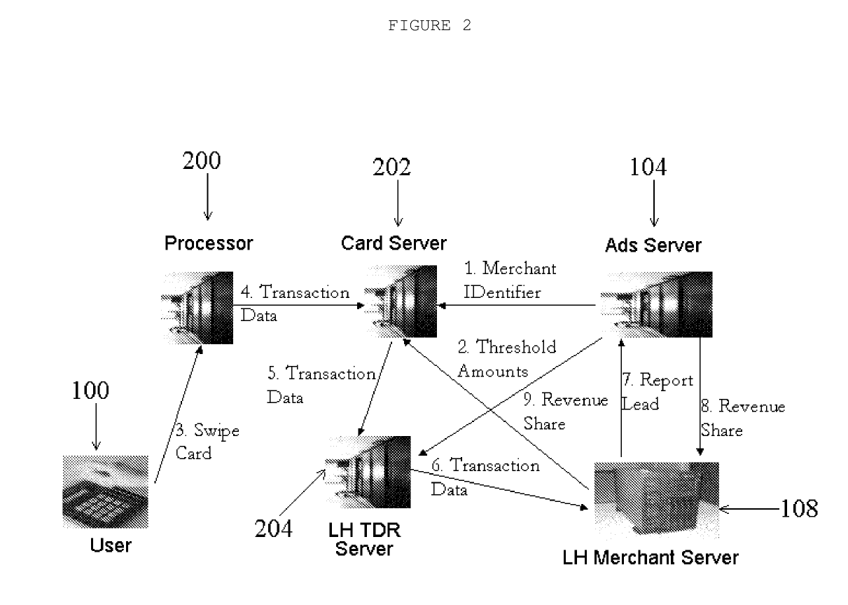

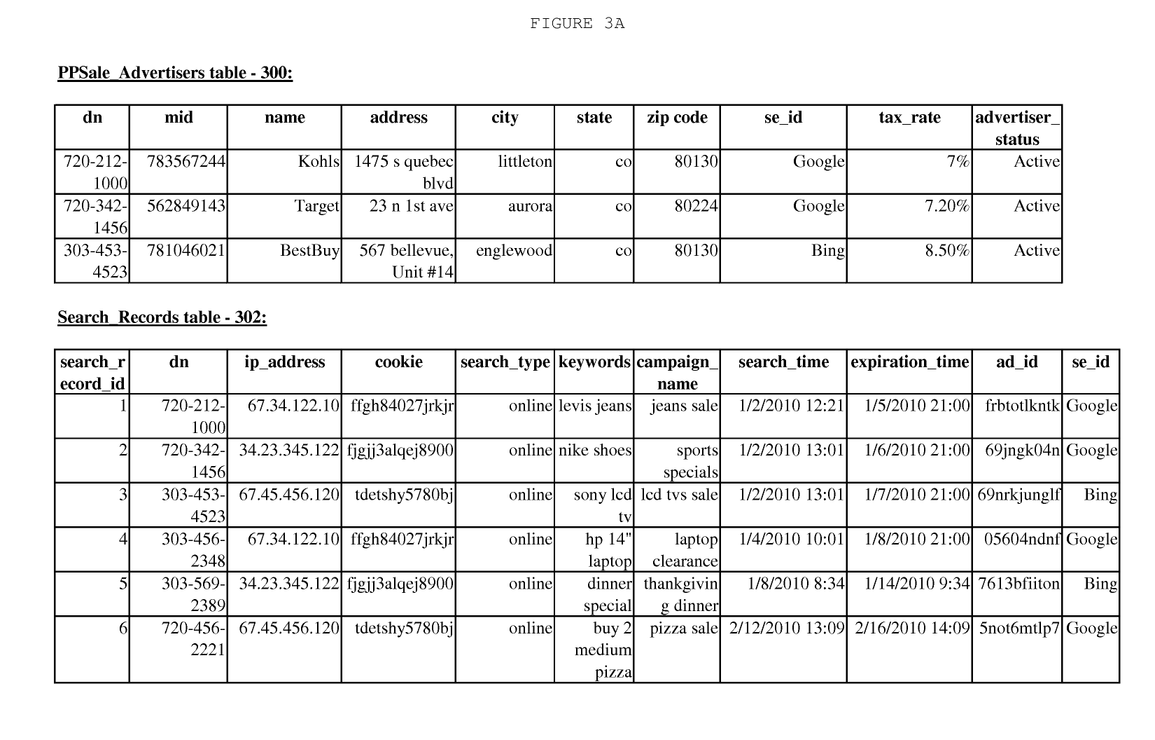

FIG. 2 is a perspective view of the associating an in-store purchase transaction to search, in accordance with the invention. After performing a search, user 100 goes to the store and makes an in-store purchase transaction at the PPSale Advertiser 112 by using a credit card, debit card, or gift card. The card terminal at the store passes the transaction data to the Processor 200. The transaction data include: among other parameters, card_number, sale_amount, mid, transaction_time, and terminal_identifier (tid). The Processor 200 may be a Bank or a 3rd party vendor with whom the merchant opens an account for accepting credit, debit, and debit cards. The Processor 200 consists of one or more computers interconnected in a data center(s). The Processor 200 issues the mid to the Advertiser 112, takes care of crediting and debiting the merchant account with amounts related to Auth transactions, Void transactions, and Chargebacks, in a Bank. The Processor 200 also maintains one or more card terminals at the store.

The Processor 200 passes the transaction data to the Card Server 202. The Card Server 202 consists of one or more computers interconnected in a data center(s) and hosted either inside or outside the firewall of the Card Brand such as Visa, MasterCard, and Amex, or a 3rd party vendor.

If it were a Sale (i.e. Auth) type of transaction, then for the mid+sale_amount combination, Card Server 202 determines the closest matching threshold_amt (i.e. equal to min_amt_charged field sent via a web service to the LH TDR Server 204 mentioned in the next step) by comparing the min_amt and max_amt fields (i.e. sale_amount must be between these two values) in the records of the Threshold_Amounts table; If there is more than one record that fits the price range in the threshold_amounts table, then select one record that has the lowest max_amt value. Card Server 202 then invokes a web service running in the LH TDR Server 204 and sends the values of: transaction_type (=Auth), transaction_id (encrypted), mid, card_number (encrypted), last_{—}4, min_amt_charged (=threshold_amt column), and transaction_time (clear-text). Upon receipt of the message, LH TDR Server 204 creates a record in the PPSale_Qualifiers 402 table, then invokes a web service running in LH Merchant Server 108 that will execute the Correlation Logic. Parameters sent include: transaction_type (=Auth), transaction_id, mid, card_number, last_{—}4, brand_id, min_amt_charged, and transaction_time.

On the other hand, if it were a Void transaction, Card Server 202 invokes a web service running in the LH TDR Server 204 and send the values of: transaction_type (=Void), transaction_id (encrypted and same value as the corresponding Auth transaction sent previously), and mid. Upon receipt of the message, LH TDR Server 204 verifies the existence of a record in the PPSale_Qualifiers 402 table for the transaction_id received and, if successful, invokes a web service running in LH Merchant Server 108 that will execute the Correlation Logic. Parameters sent include: transaction_type (=Void), transaction_id, mid, card_number, last_{—}4, brand_id, min_amt_charged, and transaction_time.

LH TDR Server 204 consists of one or more computers interconnected in a data center(s) and hosted either inside or outside the firewall of the Card Brand, or a 3rd party vendor. Similarly, LH Merchant Server 108 consists of one or more computers interconnected in a data center(s) and hosted either inside or outside the firewall of the search system, a telephone company, or a 3rd party vendor.

LH TDR Server 204 functionality includes: 1) Communicating with Card Server 202 and LH Merchant Server 108; 2) Verifying that the mid sent by the Card Server 202 is present in the PPSale_DNs 400 table; 3) Storing Transaction Detail Records (TDRs) of valid leads raised by LH Merchant Server 108; and 3) Display transaction reports of leads upon request from employees of Card Brand.

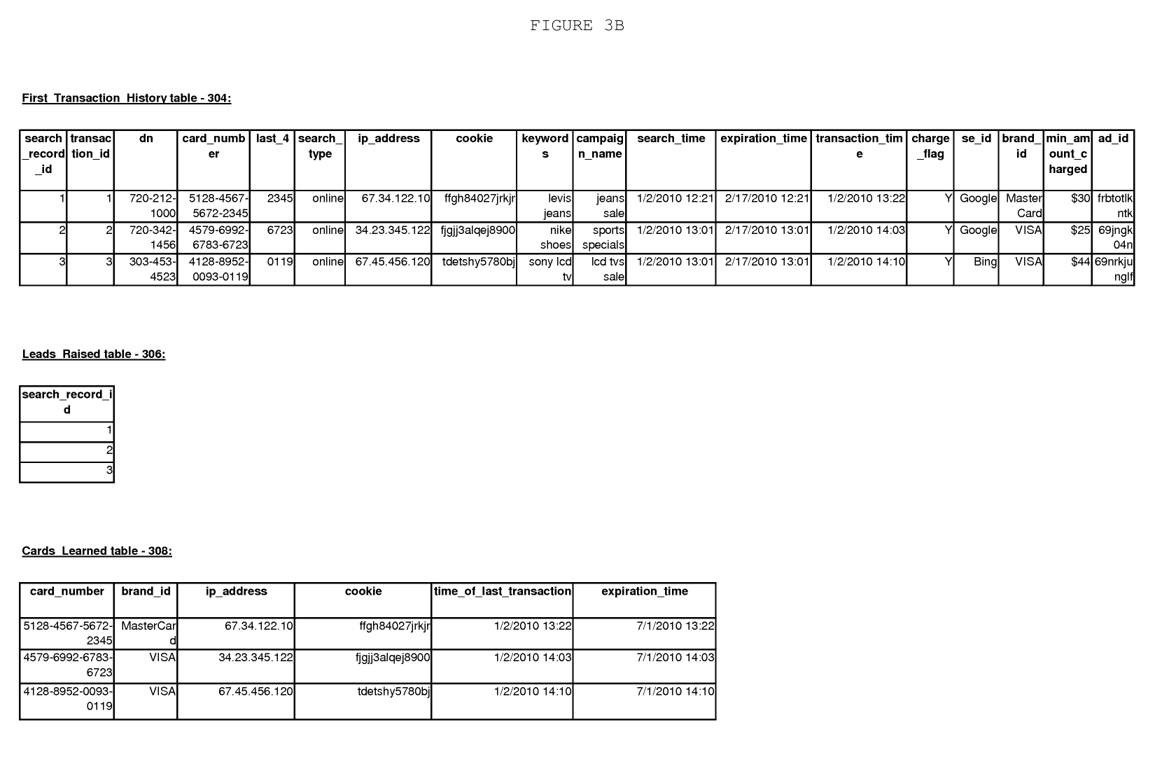

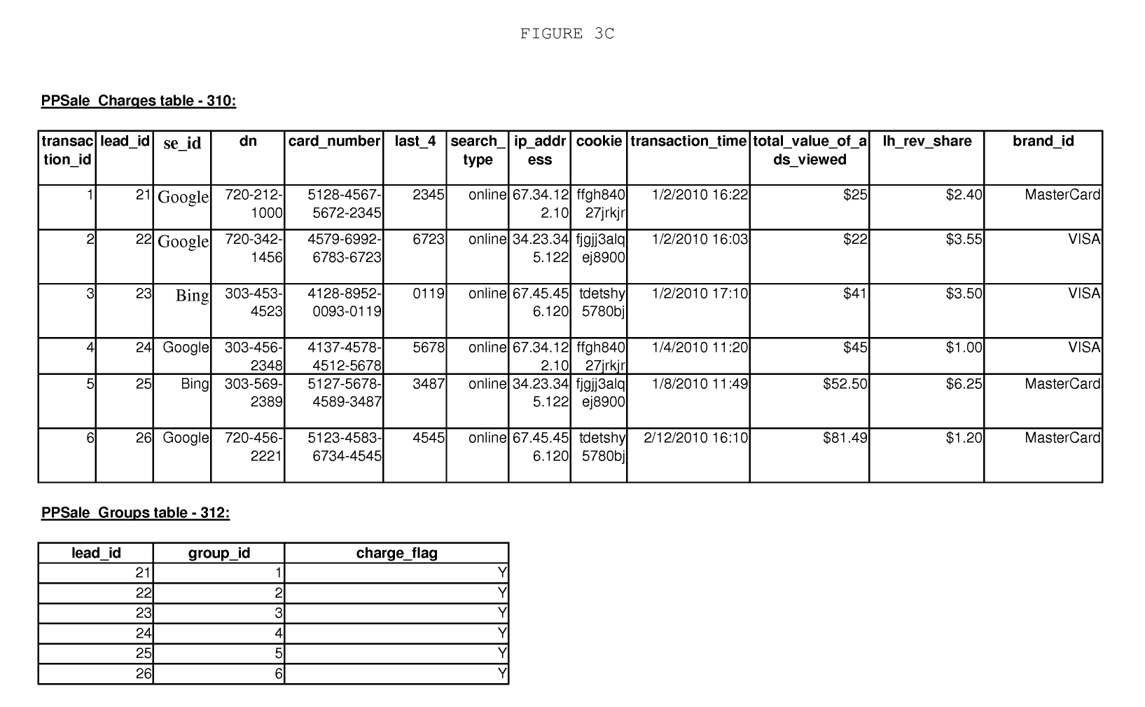

FIGS. 3A, 3B, 3C, and 3D are an exploded view of the LH Merchant DB tables schema, in accordance with the invention. It should be noted that the tables described in FIGS. 3A, 3B, 3C, and 3D as part of the LH Merchant DB may or may nor reside within LH Merchant Server 108.

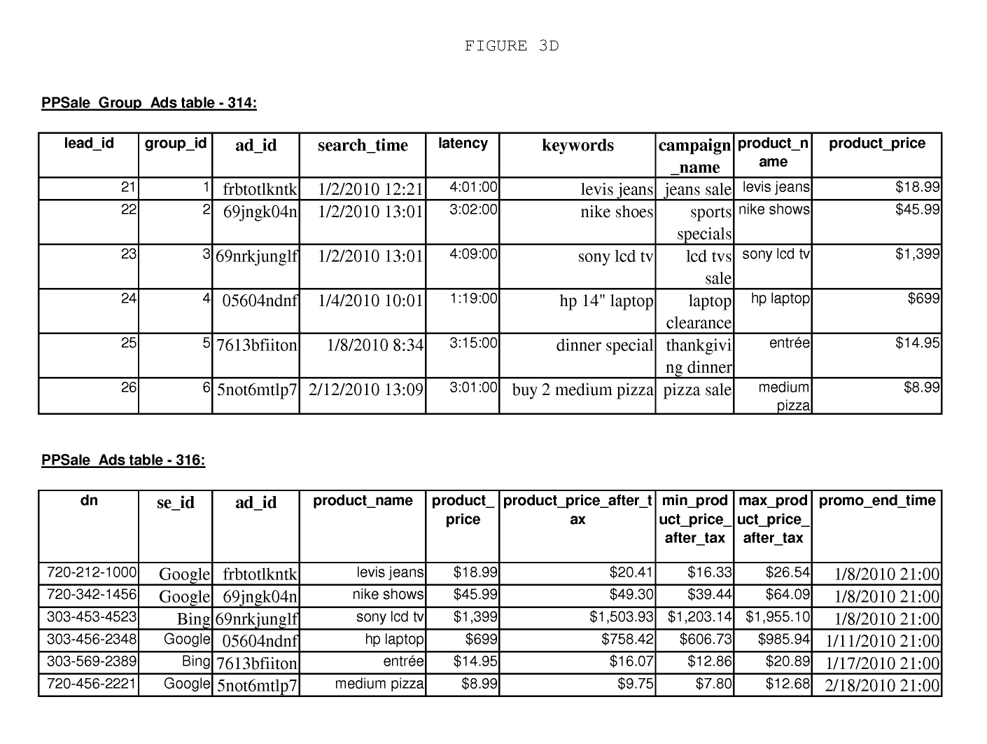

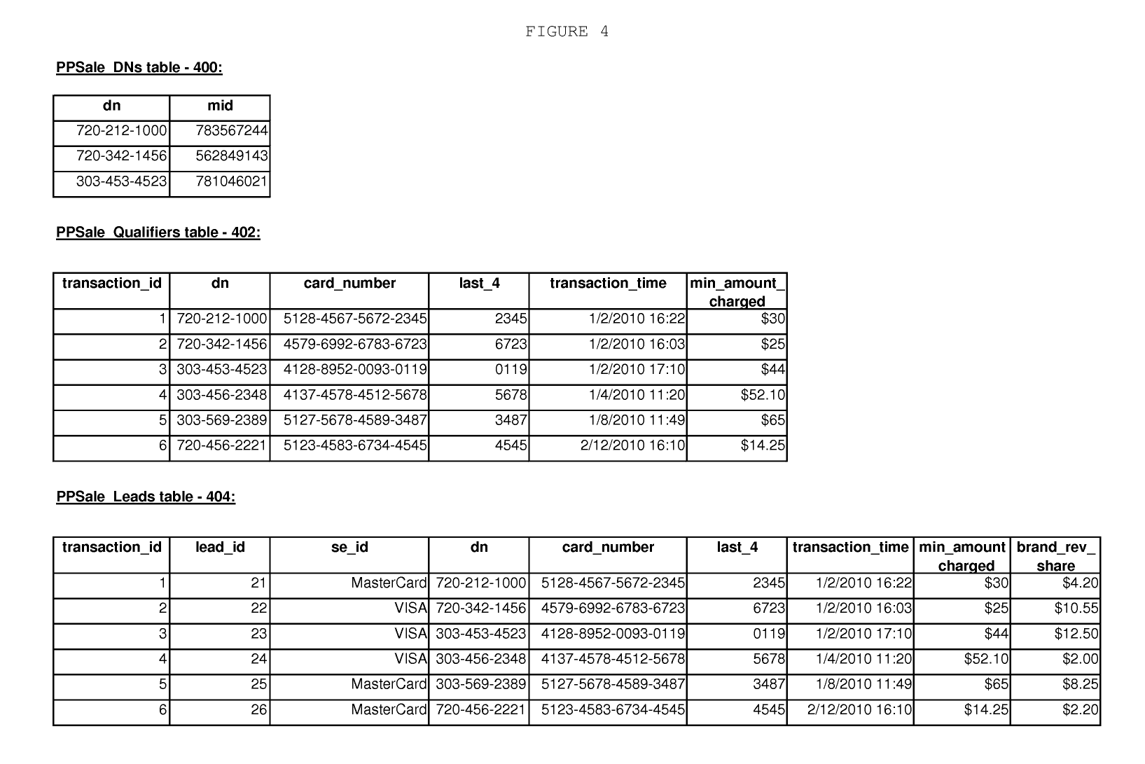

FIG. 4 is an exploded view of the LH TDR Server 204 tables, in accordance with the invention.

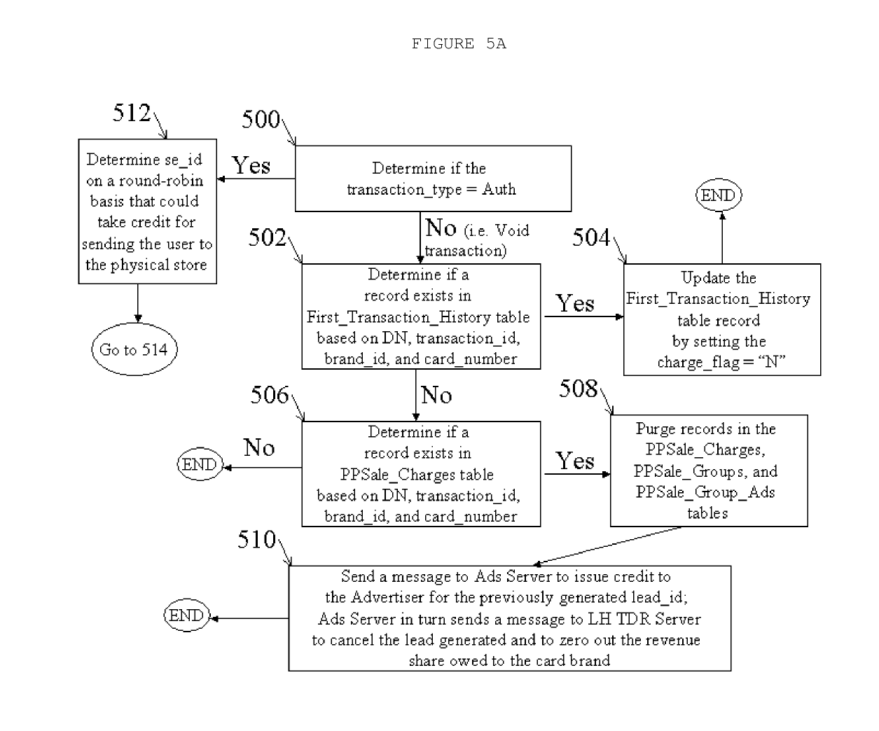

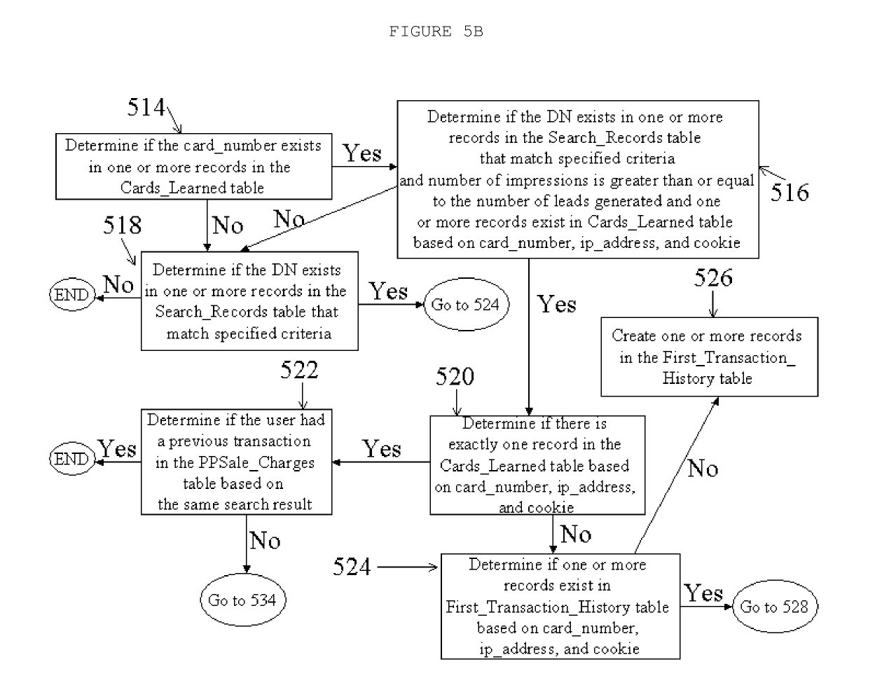

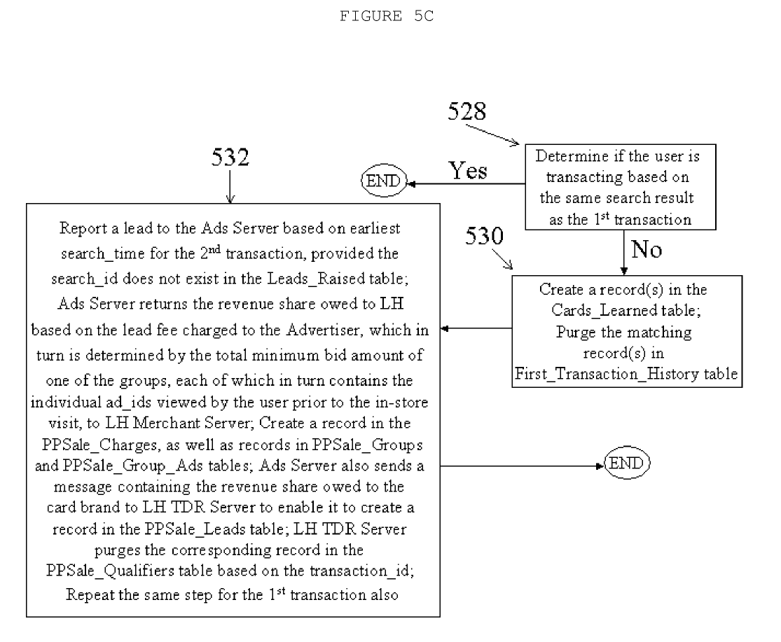

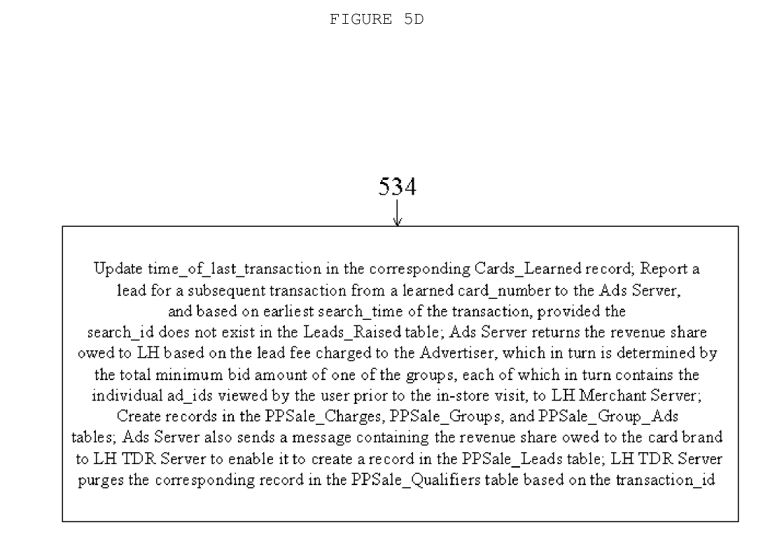

Upon receipt of a message from LH TDR Server 204, LH Merchant Server 108 validates the mid as being a valid PPSale Advertiser 112 per the PPSale_Advertisers 300 table and then executes a Correlation Logic described in FIGS. 5A, 5B, 5C, and 5D, in accordance with the invention.

More specifically, in FIG. 5A and step 500 the Correlation Logic determines if the transaction_type is an Auth type of transaction. If so, then step 512 determines the se_id on a round-robin basis that could take credit for sending the user 100 to the physical store for making the purchase of poducts/services for which the user 100 had viewed one or more ads in one or more search results. In FIG. 5B, step 514 the Correlation Logic determines if the card_number received from LH TDR Server 204 exists in one or more records in the Cards_Learned 308 table. If so, in step 516 it determines if the DN exists in one or more records in the Search_Records 302 table such that the transaction_time is greater than search_time as well as the transaction_time is less than the promo_end_time and the min_amt_charged is equal to the product_price_after_tax of one or more ad_ids and number of impressions is greater than or equal to the number of leads generated and one or more records exist in the Cards_Learned 308 table based on card_number received in the message from the LH TDR Server 204, and the IP Address and Cookie values of the said records of the Cards_Learned 308 table match those values present in the said records of the Search_Records 302 table. If no records exist, then in step 518 Correlation Logic determines if a valid search exists for the DN in the Search_Records 302 table such that the number of impressions is greater than or equal to the number of leads generated and the transaction_time is greater than search_time as well as the transaction_time is less than the promo_end_time and the min_amt_charged is equal to the product_price_after_tax of one or more ad_ids. If so, the Correlation Logic proceeds to step 524 as explained below.

In step 524, the Correlation Logic determines if one or more records exist in First_Transaction_History 304 table based on card_number, ip_address, and cookie. If no record exists, then in step 526 it creates one or more records

in the First_Transaction_History 304 table. If there is at least one record, then the Correlation Logic proceeds to FIG. 5C, step 528.

In step 520, the Correlation Logic determines if there is exactly one record in the Cards_Learned 308 table based on card_number, ip_address, and cookie. If no record exists, then it proceeds to step 524 as explained above. On the other hand, if a record exists, then in step 522 the Correlation Logic determines if the user 100 had a previous transaction in the PPSale_Charges 310 table based on the same search result. If none, then it proceeds to step 534. This is done to ensure the learning algorithm is not weakened so that the card_number is not learned in situations where the user 100 does shopping at two different stores as a result of a single search result.

In step 528, the Correlation Logic determines if the user 100 is transacting based on the same search result as the 1st transaction. If not, then in step 530 it creates one or more records in the Cards_Learned 308 table, purges the matching record(s) in the First_Transaction_History 304 table. In step 532, it reports a lead to the Ads Server 104 with one or more groups as explained through an example in FIG. 7, step 708, and based on the earliest search_time for the 2nd transaction, provided the search_id does not exist in the Leads_Raised 306 table. Ads Server 104 returns the revenue share owed to LH based on the lead fee charged to the Advertiser 112, which in turn is determined by the total minimum bid amount of one of the groups, each of which in turn contains the individual ad_ids viewed by the user 100 prior to the in-store visit, to LH Merchant Server 108. The Correlation Logic then creates a record in the PPSale_Charges 310 as well as one or more records in the PPSale_Groups 312 and PPSale_Group_Ads 314 tables. Ads Server 104 also sends a message containing the revenue share owed to the Card Brand's LH TDR Server 204 to enable it to create a record in the PPSale_Leads 404 table. LH TDR Server 204 purges the corresponding record in the PPSale_Qualifiers 402 table based on the transaction_id. Then, Correlation Logic repeats the step 532 for the 1st transaction also.

In FIG. 5D, step 534, the Correlation Logic updates the time_of_last_transaction in the corresponding Cards_Learned 308 record. Then, it reports a lead for a subsequent transaction from a learned card_number to the Ads Server 104 with one or more groups as explained through an example in FIG. 7, step 708, and based on the earliest search_time of the transaction, provided the search_id does not exist in the Leads_Raised 306 table. Ads Server 104 returns the revenue share owed to LH based on the lead fee charged to the Advertiser 112, which in turn is determined by the total minimum bid amount of one of the groups, each of which in turn contains the individual ad_ids viewed by the user 100 prior to the in-store visit, to LH Merchant Server 108. The Correlation Logic then creates a record in the PPSale_Charges 310, as well as one or more records in the PPSale_Groups 312 and PPSale_Group_Ads 314 tables. Ads Server 104 also sends a message containing the revenue share owed to the Card Brand's LH TDR Server 204 to enable it to create a record in the PPSale_Leads 404 table. LH TDR Server 204 purges the corresponding record in the PPSale_Qualifiers 402 table based on the transaction_id.

In FIG. 5A, step 502, for a Void transaction the Correlation Logic determines if a record exists in First_Transaction_History 304 table based on DN, transaction_id, brand_id, and card_number. If a record exists, then in step 504 it updates the First_Transaction_History 304 table record by setting the charge_flag=“N.” If no record exits, then in step 506 it determines if a record exists in PPSale_Charges 310 table based on DN, transaction_id, brand_id, and card_number. If so, in step 508 it purges the records in the PPSale_Charges 310, PPSale_Groups 312, and PPSale_Group_Ads 314 tables. Then, in step 510 it sends a message to the Ads Server 104 to issue a credit to the Advertiser 112 for the previously generated lead id. Ads Server 104 in turn sends a message to LH TDR Server 204 to cancel the lead generated and to zero out the revenue share owed to the Card Brand.

A scheduled process running in LH Merchant Server 108 will purge records in the First_Transaction_History 304 table, provided the expiration_time is greater than current time. In addition, another scheduled process running in LH Merchant Server 108 will purge records in the Cards_Learned 308 table, provided the current time is greater than the time_of_last_transaction+a predetermined value. Another scheduled process running in the LH Merchant Server 108 will purge records in the Threshold_Amounts table with exp_time greater than current time. Yet another sheduled process running in the LH Merchant Server 108 will purge records in the PPSale_Ads 316 table with exp_time greater than current time.

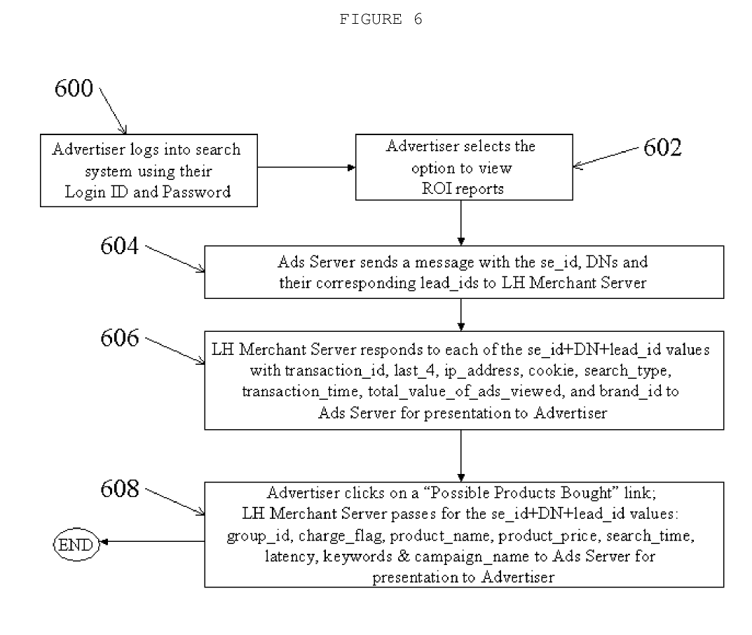

FIG. 6 is an exploded view of the ROI reports, in accordance with the invention. In step 600, the Advertiser 112 logs into their account with the search system using their Login ID and Password. In step 602, the Advertiser 112 selects the option to view the PPSale ROI reports. In step 604, the Ads Server 104 sends a message with the se_id, DNs and their corresponding lead_ids to LH Merchant Server 108. The message consists of one or more DNs configured in the account belonging to the Advertiser 112 as well as one or more said lead_ids that were reported to the Ads Server 104 when the Correlation Logic raised leads to the Advertiser 112 for the possible products/services purchased based on one or more searches.

In step 606, LH Merchant Server 108 responds to each of the se_id+DN+lead_id values with transaction_id, last_{—}4, ip_address, cookie, search_type, transaction_time, total_value_of_ads_viewed, and brand_id to Ads Server 104 for presentation to the Advertiser 112, along with a link called “Possible Products Bought.” In step 608, the Advertiser 112 clicks on a “Possible Products Bought” link. LH Merchant Server 108 passes for the se_id+DN+lead_id values: group_id, charge_flag, product_name, product_price, search_time, latency, keywords, and campaign_name to Ads Server 104 for presentation to the Advertiser 112. For privacy reasons, the said ip_address, cookie, keywords, and campaign_name fields may be encrypted when originally received from the Search Server 102 as part of the search results.

FIG. 7 shows an exploded view of an example for calculating the minimum bid amount to be charged for a transaction by the Ads Server 104. More specifically, step 700 shows an example of the ads viewed by a user 100 with their corresponding product_price from a given store at a location. When an ad is viewed by the user 100 through the search results, in step 702 the LH Merchant Server 108 automatically generates a record in the Threshold_Amounts table and passes the information onto the Card Server 202, which in turn stores it in its own database table called Threshold_Amounts. In step 704, the user 100 that had viewed one or more ads through one of the Search Engines makes a purchase in-store using a credit, debit, or gift card. The transaction will be received by the Processor 200, which in turn forwards it to the Card Server 202. In step 706, the Card Server 202 consults the Threshold_Amounts table to determine the closest matched threshold_amt based on the various price ranges and the sale_amount. The Card Server 202 passes the said threshold_amt as the min_amt_charged to the card and sends the transaction data onto the LH TDR Server 204, which in turn passes it to the Correlation Logic running in the LH Merchant Server 108.

Step 708 shows the possible different combinations of groups of ads whose sum of the product_price of the ad_id values will be less than or equal to the min_amt_charged value. Step 710 shows the various bid amounts the Advertiser 112 has specified for one or more Keywords under one or more Campaigns of PPSale Ads in the Ads Server 104. As described in FIG. 2, LH Merchant Server 108 reports a lead with one or more groups of ads by sending the parameters described in the PPSale_Group_Ads 314 table, along with the lead_id, DN, brand_id, transaction_id, transaction_time, search_type, ip_address, and cookie, to the Ads Server 104 denoted by the se_id value. In step 712, Ads Server 104 uses the DN and the one or more sets of ad_id, keywords and campaign_name values sent by LH Merchant Server 108 to compute the bid amounts for all the PPSale_Group_Ads 314 through a look up of the corresponding bid amounts specified by the Advertiser 112 per step 710. In step 714, Ads Server 104 determines the lowest bid amount of one of the groups of ads represented through PPSale_Group_Ads 314 table. Thereafter, Ads Server 104 sends a response with the group_id that had the lowest bid amount and revenue share owed to LH Merchant Server 108 as shown in FIG. 2. LH Merchant Server 108 updates the PPSale_Charges 310 record with the revenue share value received. In addition, Ads Server 104 also sends revenue share owed to the Card Brand's LH TDR Server 204 as shown in FIG. 2. LH TDR Server 204 creates a record in the PPSale_Leads 404 table with the revenue share received for the said transaction_id as explained in an earlier section.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A pay-per-sale ad system for providing proof that the physical store transaction is associated to an online or mobile search and in an anonymous manner, comprising:
means for performing one or more online and mobile searches; and making an in-store purchase by swiping a credit card, debit card, or gift card at the card terminal;
means for creating one or more ppsale advertisers consisting of store name, address, city, state, zip code, directory number (dn), merchant identifier (mid) issued by the processor, sales tax in percentage, and billing details; maintaining a reference data of product catalog consisting of one or more products/services and applicable price ranges in the form of minimum and values; creating and storing one or more ppsale ads comprising a product/service price, one or more keywords associated with one or more campaign names and configured by advertiser; verifying that the product price of each ppsale ad configured is within the allowed minimum and maximum values as specified by the product catalog; sending one or more ppsale advertiser details to one or more card servers; determining the lowest bid amount applicable to one of the groups of ads having the most number of ad ids as reported by lh merchant server;
means for receiving relevant one or more ads from ads server and natural results from the organic listings db; consolidating the paid ads and natural results for presentation to the user; and passing the one or more search results containing one or more ppsale ads info consisting of search time, search type (online or mobile), ip address for online searches/carrier userid representing the mobile and sent through the wap gateway of the mobile carrier for mobile searches (maybe encrypted), cookie (maybe encrypted), dn, ad id, keywords (maybe encrypted or proxy), and campaign_name (maybe encrypted or proxy) to lh merchant server;
means for receiving one or more ppsale advertisers information such as se_id, dn, name, address, city, state, zip_code, sales_tax_rate, and mid from one or more ads servers and creating one or more records in the ppsale_advertisers table; sending one or more ppsale advertisers information to one or more card servers; receiving one or more ppsale ads information such as se_id, dn, mid, product_name, product_price, and promo_end_time from one or more ads servers, computing the product_price_after_tax, min_product_price_after_tax, and max_product_price_after_tax values, and creating one or more records in the ppsale_ads table; receiving for the said one or more ppsale ads a final end date of promotion in order to apply automatic extension of the promo_end_time to the said ad_id in the ppsale_ads table from one or more ads servers; receiving one or more search results from the one or more search servers, where each search results contains one or more ppsale ads, and creating one or more records in the search_records table containing the search_record_id, se_id, search_time, ip address for online searches/carrier userid for mobile searches (maybe encrypted), cookie (maybe encrypted), search_type, dn, ad id, keywords (maybe encrypted), and campaign_name (maybe encrypted), provided the dn is present in the ppsale_advertisers table; creating one or more records in the threshold_amounts table based on the product_price_after_tax value of each of the said ad ids received in the search results as well as recursively adding the product_price_after_tax to the threshold_amt in each of the records of the threshold_amounts table, provided the record matching the combination based on the mid, ad_id, threshold_amt, and exp_time does not already exist; sending the one or more records created in the threshold_amounts table to the one or more card servers; creating one or more records in the cards_learned table if either the said ip address/carrier userid or cookie had changed as compared to the existing one or more records in the cards_learned table; creating one or more records in the first_transaction_history table if either the said ip address/carrier userid or cookie had changed as compared to the existing one or more records in the first_transaction_history table; updating the existing one or more records in the first_transaction_history_table if the said ip address/carrier userid and cookie had not changed; receiving one or more auth and void transactions from one or more lh tdr servers running at one or more card brands; executing correlation logic to a) determine the se_id on a round-robin basis the search system that could take credit for sending the user to the physical store from one or more search engines; b) create one or more records in the first_transaction_history table for the 1st purchase transaction i.e. auth transaction completed, provided the dn to which the card transaction applies is present in the ppsale_advertisers table and a valid one or more records containing the said dn are present in the search_records table; c) learn a card based on a 2nd purchase transaction from the same card_number as that present in one or more records of the first_transaction_history table and the same ip address/carrier userid and cookie values present in the said records of the first_transaction_history table as that present in one or more records of the search_records table and the said records of the search_records table containing the same dn to which the said purchase transaction is applied; d) match the card_number to one or more records in the cards_learned table containing the same card_number and match the ip address/carrier userid and cookie contained in the said record of the cards_learned table against one or more records of the search_records table containing the same ip address/carrier userid and cookie and match the dn in the said record of the search_records table to which the said subsequent purchase transaction is applied; e) create one or more groups of ads viewed such that the sum of the product prices of the individual products/services, including sales tax, is equal to the minimum amount charged as reported by the card server; f) raise one or more leads for the ads viewed contained in the respective groups to ads server for the 1st and/or 2nd purchase transactions when a card is learned or when one or more subsequent purchase transactions is applied from an already learned card_number based on earliest search_time of one of the said records of the search_records table while ensuring that the number of leads for the dn is less than or equal to the number of ad impressions of various ad_ids and that there is no more than one lead for an impression of the ad by verifying that the search_record_id of the said record of the search_records table is not already present in the leads_raised table; g) create one or more records in the ppsale_charges, ppsale groups, and ppsale group ads tables with the said lead fee received from the ads server; and h) ensure that no lead fee is raised for a void transaction; reporting the said one or more leads to the appropriate lh tdr server running at the concerned card brand; facilitating the viewing of the roi report by one or more authorized employees of the one or more card brands and one or more advertisers; and receiving one or more ppsale advertiser campaign termination notices from one or more ads server and passing the termination notice to one or more card servers, provided the advertiser has terminated the said campaign from the last search engine;
means for capturing and passing one or more card sale transactions data to the card server for authorization by the card issuer; capturing and passing one or more card transactions data to the card server for voiding one or more previous sale transactions by the card issuer;
means for receiving one or more transactions such as auth and void from the card server, where the message contains transaction_type (auth vs. void), transaction_id, mid (i.e. merchant identifier), card_number (encrypted), last_{—}4, min_amount_charged, and transaction_time; verifying that the mid is present in the ppsale_dns table; creating one or more records in the ppsale_qualifiers table containing the transaction_id, transaction_type, mid, card_number, last_{—}4, min_amount_charged, and transaction_time; forwarding one or more transaction events such as auth and void with the parameters of transaction_id, transaction_type, mid, card_number, last_{—}4, min_amount_charged, and transaction_time to lh merchant server; creating one or more leads in the ppsale_leads table upon receipt of one or more valid leads from the lh merchant server; facilitating the viewing of roi report by one or more authorized employees of the card brand; and purging one or more records in the ppsale_dns table when the advertisers end their ppsale campaigns in one or more ads servers as reported by the card server;
means for creating an account in the search system's ads server; creating one or more ppsale campaigns under the account for one or more dns, each containing one or more ad groups, which in turn contains one or more keywords; bidding for one or more keywords; getting charged for one or more valid leads for ads that the user views as part of the search results per the correlation logic; and having the privilege to view the roi report;
means for storing one or more ppsale advertisers' information that signed up with one or more ads servers;
means for storing one or more of the ppsale ads viewed by one or more users and received in the search results message from one or more search servers with an expiration_time equal to promo_end_time column value of the ppsale_ads table as determined by the se_id, dn, and and_id combination;
means for storing one or more 1st card transactions with an expiration_time equal to the search_time+a predetermined value, provided the dn to which the transaction applies is found in one or more valid records of the search_records table; ensuring that when a 2nd card transaction attempt is received, the said correlation logic makes a determination as to whether or not the transaction is from the same card_number as that present in one or more records of the first_transaction_history table and for a dn present in a valid one or more records of the search_records table and the ip address/carrier userid and cookie values present in the said records of the first_transaction_history table match those in the said records of the search_records table; and updating one or more existing records when a void transaction i.e. set the charge_flag=“n” occurs with transaction_id, card_number and mid matching one or more records present in the first_transaction_history table as well as when new search results are received with ip address/carrier userid and cookie values that match one or more records of the first_transaction_history table;
means for storing one or more cards learned against one or more said ip address/carrier userid and cookie from one or more records of the first_transaction_history and search_records tables per the said correlation logic; updating one or more existing records when new search results are received with ip address/carrier userid and cookie values that match one or more records of the cards_learned table from one or more search servers;
means for storing one or more valid leads per the said correlation logic, associated with one or more card_numbers as well as one or more ip address/carrier userid and cookie from one or more records in the search_records table that also contains a dn to which the transaction is associated and for which a lead fee based on the lowest bid amount of one of the groups of ads is charged by the ads server;
means for storing one or more ppsale advertisers' information that signed up with the one or more ads servers; and verifying that the mid passed from the card server is a valid ppsale advertiser before the lh tdr server processes further the incoming message from the card server;
means for storing one or more auth transactions received from the card server, after determining that the mid contained in the message is a valid ppsale advertiser, where the transaction details contain the parameters of transaction_type, transaction_id, min_amt_charged, mid, card_number, last_{—}4, and transaction_time; and maintaining the said auth transactions in the table until such time as the card server reports either a void transaction for the said transaction_id or the lh merchant server reports for the said transaction_id a lead, at which time the said record in the table based on the said transaction_id will be purged;
means for storing one or more leads reported by the one or more ads server that in turn were triggered by the said correlation logic; zeroing out the revenue share earned by the card brand for one or more void transactions as reported by the one or more ads servers and triggered by the said correlation logic; and displaying the revenue share earned by the card brand when one or more authorized employees of the card brand view the leads reported by the one or more ads servers;
means for storing one or more leads raised by the said correlation logic so as to ensure that no more than no more than one lead is raised for an impression of the ppsale ad;
means for receiving one or more ppsale advertisers details containing the advertiser name, address, city, state, zip code, mid, and dn from the lh merchant server; forwarding one or more advertiser details, including mid and dn, to the lh tdr server, which in turn will store the values in the ppsale_dns table; receiving and storing one or more threshold amounts from the lh merchant server for the ads viewed by one or more users in the threshold_amounts table; receiving one or more card transactions data relating to auth and void transactions from processor containing, among other parameters, the transaction_type (auth vs. void), card_number, sale_amount, mid, terminal_identifier (tid), and transaction_time; generating a unique transaction_id; determining the closest matching threshold amount for the mid and sale_amount combination and treating the matching threshold_amount as the min_amount_charged to the card before passing it on to the lh tdr server; sending the transaction details consisting of the transaction_type (auth vs. void), transaction_id, mid, card_number (encrypted), last_{—}4, min_amount_charged, and transaction_time to the lh tdr server; purging one or more records in the threshold_amounts table when their expiration_time is reached; purging one or more ppsale advertisers when the advertisers end their ppsale campaigns in one or more ads servers; and receiving the ppsale campaign termination notice from lh merchant server and passing the notice onto the lh tdr server;
means for storing one or more groups of ads with a flag that indicates whether or not the group forms the basis of a valid lead as determined by the said correlation logic, wherein the said record contains lead_id, group_id, and charge_flag;
means for storing one or more ads contained in one or more groups that form the basis of a valid lead as determined by the said correlation logic, wherein the said record contains lead_id, group_id, ad_id, search_time, latency, keywords, campaign_name, product_name, and product_price; and
means for storing one or more ppsale ads as configured by the one or more advertisers in the one or more ads servers, wherein the said record contains dn, se_id, ad_id, product_name, product_price, product_price_after_tax that is computed based on the sales tax rate applicable to the mid, min_product_price_after_tax that is derived based on the product_price_after_tax and a min_threshold_percentage that allows the user to shop for a lower priced product/service than the one the user found in the search results, max_product_price_after_tax that is derived based on the product_price_after_tax and a max_threshold_percentage that allows the user to shop for a higher priced product/service than the one the user found in the search results, and promo_end_time.

2. The pay-per-sale ad system in accordance with claim 1, wherein said means for performing one or more online and mobile searches; and making an in-store purchase by swiping a credit card, debit card, or gift card at the card terminal comprises an user.

3. The pay-per-sale ad system in accordance with claim 1, wherein said means for creating one or more ppsale advertisers consisting of store name, address, city, state, zip code, directory number (dn), merchant identifier (mid) issued by the processor, sales tax in percentage, and billing details; maintaining a reference data of product catalog consisting of one or more products/services and applicable price ranges in the form of minimum and values; creating and storing one or more ppsale ads comprising a product/service price, one or more keywords associated with one or more campaign names and configured by advertiser; verifying that the product price of each ppsale ad configured is within the allowed minimum and maximum values as specified by the product catalog; sending one or more ppsale advertiser details to one or more card servers; determining the lowest bid amount applicable to one of the groups of ads having the most number of ad ids as reported by lh merchant server comprises an ads server.

4. The pay-per-sale ad system in accordance with claim 1, wherein said means for receiving relevant one or more ads from ads server and natural results from the organic listings db; consolidating the paid ads and natural results for presentation to the user; and passing the one or more search results containing one or more ppsale ads info consisting of search time, search type (online or mobile), ip address for online searches/carrier userid representing the mobile and sent through the wap gateway of the mobile carrier for mobile searches (maybe encrypted), cookie (maybe encrypted), dn, ad id, keywords (maybe encrypted or proxy), and campaign_name (maybe encrypted or proxy) to lh merchant server comprises a search server.

5. The pay-per-sale ad system in accordance with claim 1, wherein said means for receiving one or more ppsale advertisers information such as se_id, dn, name, address, city, state, zip_code, sales_tax_rate, and mid from one or more ads servers and creating one or more records in the ppsale_advertisers table; sending one or more ppsale advertisers information to one or more card servers; receiving one or more ppsale ads information such as se_id, dn, mid, product_name, product_price, and promo_end_time from one or more ads servers, computing the product_price_after_tax, min_product_price_after_tax, and max_product_price_after_tax values, and creating one or more records in the ppsale_ads table; receiving for the said one or more ppsale ads a final end date of promotion in order to apply automatic extension of the promo_end_time to the said ad_id in the ppsale_ads table from one or more ads servers; receiving one or more search results from the one or more search servers, where each search results contains one or more ppsale ads, and creating one or more records in the search_records table containing the search_record_id, se_id, search_time, ip address for online searches/carrier userid for mobile searches (maybe encrypted), cookie (maybe encrypted), search_type, dn, ad id, keywords (maybe encrypted), and campaign_name (maybe encrypted), provided the dn is present in the ppsale_advertisers table; creating one or more records in the threshold_amounts table based on the product_price_after_tax value of each of the said ad ids received in the search results as well as recursively adding the product_price_after_tax to the threshold_amt in each of the records of the threshold_amounts table, provided the record matching the combination based on the mid, ad_id, threshold_amt, and exp_time does not already exist; sending the one or more records created in the threshold_amounts table to the one or more card servers; creating one or more records in the cards_learned table if either the said ip address/carrier userid or cookie had changed as compared to the existing one or more records in the cards_learned table; creating one or more records in the first_transaction_history table if either the said ip address/carrier userid or cookie had changed as compared to the existing one or more records in the first_transaction_history table; updating the existing one or more records in the first_transaction_history table if the said ip address/carrier userid and cookie had not changed; receiving one or more auth and void transactions from one or more lh tdr servers running at one or more card brands; executing correlation logic to a) determine the se_id on a round-robin basis the search system that could take credit for sending the user to the physical store from one or more search engines; b) create one or more records in the first_transaction_history table for the 1st purchase transaction i.e. auth transaction completed, provided the dn to which the card transaction applies is present in the ppsale_advertisers table and a valid one or more records containing the said dn are present in the search_records table; c) learn a card based on a 2nd purchase transaction from the same card_number as that present in one or more records of the first_transaction_history table and the same ip address/carrier userid and cookie values present in the said records of the first_transaction_history table as that present in one or more records of the search_records table and the said records of the search_records table containing the same dn to which the said purchase transaction is applied; d) match the card_number to one or more records in the cards_learned table containing the same card_number and match the ip address/carrier userid and cookie contained in the said record of the cards_learned table against one or more records of the search_records table containing the same ip address/carrier userid and cookie and match the dn in the said record of the search_records table to which the said subsequent purchase transaction is applied; e) create one or more groups of ads viewed such that the sum of the product prices of the individual products/services, including sales tax, is equal to the minimum amount charged as reported by the card server; f) raise one or more leads for the ads viewed contained in the respective groups to ads server for the 1st and/or 2nd purchase transactions when a card is learned or when one or more subsequent purchase transactions is applied from an already learned card_number based on earliest search_time of one of the said records of the search_records table while ensuring that the number of leads for the dn is less than or equal to the number of ad impressions of various ad_ids and that there is no more than one lead for an impression of the ad by verifying that the search_record_id of the said record of the search_records table is not already present in the leads_raised table; g) create one or more records in the ppsale_charges, ppsale groups, and ppsale group ads tables with the said lead fee received from the ads server; and h) ensure that no lead fee is raised for a void transaction; reporting the said one or more leads to the appropriate lh tdr server running at the concerned card brand; facilitating the viewing of the roi report by one or more authorized employees of the one or more card brands and one or more advertisers; and receiving one or more ppsale advertiser campaign termination notices from one or more ads server and passing the termination notice to one or more card servers, provided the advertiser has terminated the said campaign from the last search engine comprises a lh merchant server.

6. The pay-per-sale ad system in accordance with claim 1, wherein said means for capturing and passing one or more card sale transactions data to the card server for authorization by the card issuer; capturing and passing one or more card transactions data to the card server for voiding one or more previous sale transactions by the card issuer comprises a processor.

7. The pay-per-sale ad system in accordance with claim 1, wherein said means for receiving one or more transactions such as auth and void from the card server, where the message contains transaction_type (auth vs. void), transaction_id, mid (i.e. merchant identifier), card_number (encrypted), last_{—}4, min_amount_charged, and transaction_time; verifying that the mid is present in the ppsale_dns table; creating one or more records in the ppsale_qualifiers table containing the transaction_id, transaction_type, mid, card_number, last_{—}4, min_amount_charged, and transaction_time; forwarding one or more transaction events such as auth and void with the parameters of transaction_id, transaction_type, mid, card_number, last_{—}4, min_amount_charged, and transaction_time to lh merchant server; creating one or more leads in the ppsale_leads table upon receipt of one or more valid leads from the lh merchant server; facilitating the viewing of roi report by one or more authorized employees of the card brand; and purging one or more records in the ppsale_dns table when the advertisers end their ppsale campaigns in one or more ads servers as reported by the card server comprises a lh tdr server.

8. The pay-per-sale ad system in accordance with claim 1, wherein said means for creating an account in the search system's ads server; creating one or more ppsale campaigns under the account for one or more dns, each containing one or more ad groups, which in turn contains one or more keywords; bidding for one or more keywords; getting charged for one or more valid leads for ads that the user views as part of the search results per the correlation logic; and having the privilege to view the roi report comprises an advertiser.

9. The pay-per-sale ad system in accordance with claim 1, wherein said means for storing one or more ppsale advertisers' information that signed up with one or more ads servers comprises a ppsale_advertisers.

10. The pay-per-sale ad system in accordance with claim 1, wherein said means for storing one or more of the ppsale ads viewed by one or more users and received in the search results message from one or more search servers with an expiration_time equal to promo_end_time column value of the ppsale_ads table as determined by the se_id, dn, and and_id combination comprises a search_records.

11. The pay-per-sale ad system in accordance with claim 1, wherein said means for storing one or more 1st card transactions with an expiration_time equal to the search_time+a predetermined value, provided the dn to which the transaction applies is found in one or more valid records of the search_records table; ensuring that when a 2nd card transaction attempt is received, the said correlation logic makes a determination as to whether or not the transaction is from the same card_number as that present in one or more records of the first_transaction_history table and for a dn present in a valid one or more records of the search_records table and the ip address/carrier userid and cookie values present in the said records of the first_transaction_history table match those in the said records of the search_records table; and updating one or more existing records when a void transaction i.e. set the charge_flag=“n” occurs with transaction_id, card_number and mid matching one or more records present in the first_transaction_history table as well as when new search results are received with ip address/carrier userid and cookie values that match one or more records of the first_transaction_history table comprises a first_transaction_history.

12. The pay-per-sale ad system in accordance with claim 1, wherein said means for storing one or more cards learned against one or more said ip address/carrier userid and cookie from one or more records of the first_transaction_history and search_records tables per the said correlation logic; updating one or more existing records when new search results are received with ip address/carrier userid and cookie values that match one or more records of the cards_learned table from one or more search servers comprises a cards_learned.

13. The pay-per-sale ad system in accordance with claim 1, wherein said means for storing one or more valid leads per the said correlation logic, associated with one or more card_numbers as well as one or more ip address/carrier userid and cookie from one or more records in the search_records table that also contains a dn to which the transaction is associated and for which a lead fee based on the lowest bid amount of one of the groups of ads is charged by the ads server comprises a ppsale_charges.

14. The pay-per-sale ad system in accordance with claim 1, wherein said means for storing one or more ppsale advertisers' information that signed up with the one or more ads servers; and verifying that the mid passed from the card server is a valid ppsale advertiser before the lh tdr server processes further the incoming message from the card server comprises a ppsale_dns.

15. The pay-per-sale ad system in accordance with claim 1, wherein said means for storing one or more auth transactions received from the card server, after determining that the mid contained in the message is a valid ppsale advertiser, where the transaction details contain the parameters of transaction_type, transaction_id, min_amt_charged, mid, card_number, last_{—}4, and transaction_time; and maintaining the said auth transactions in the table until such time as the card server reports either a void transaction for the said transaction_id or the lh merchant server reports for the said transaction_id a lead, at which time the said record in the table based on the said transaction_id will be purged comprises a ppsale_qualifiers.

16. The pay-per-sale ad system in accordance with claim 1, wherein said means for storing one or more leads reported by the one or more ads server that in turn were triggered by the said correlation logic; zeroing out the revenue share earned by the card brand for one or more void transactions as reported by the one or more ads servers and triggered by the said correlation logic; and displaying the revenue share earned by the card brand when one or more authorized employees of the card brand view the leads reported by the one or more ads servers comprises a ppsale_leads.

17. The pay-per-sale ad system in accordance with claim 1, wherein said means for storing one or more leads raised by the said correlation logic so as to ensure that no more than no more than one lead is raised for an impression of the ppsale ad comprises a leads_raised.

18. The pay-per-sale ad system in accordance with claim 1, wherein said means for receiving one or more ppsale advertisers details containing the advertiser_name, address, city, state, zip_code, mid, and dn from the lh merchant server; forwarding one or more advertiser details, including mid and dn, to the lh tdr server, which in turn will store the values in the ppsale_dns table; receiving and storing one or more threshold amounts from the lh merchant server for the ads viewed by one or more users in the threshold_amounts table; receiving one or more card transactions data relating to auth and void transactions from processor containing, among other parameters, the transaction_type (auth vs. void), card_number, sale_amount, mid, terminal_identifier (tid), and transaction_time; generating a unique transaction_id; determining the closest matching threshold amount for the mid and sale_amount combination and treating the matching threshold_amount as the min_amount_charged to the card before passing it on to the lh tdr server; sending the transaction details consisting of the transaction_type (auth vs. void), transaction_id, mid, card_number (encrypted), last_{—}4, min_amount_charged, and transaction_time to the lh tdr server; purging one or more records in the threshold_amounts table when their expiration_time is reached; purging one or more ppsale advertisers when the advertisers end their ppsale campaigns in one or more ads servers; and receiving the ppsale campaign termination notice from lh merchant server and passing the notice onto the lh tdr server comprises a card server.

19. The pay-per-sale ad system in accordance with claim 1, wherein said means for storing one or more groups of ads with a flag that indicates whether or not the group forms the basis of a valid lead as determined by the said correlation logic, wherein the said record contains lead_id, group_id, and charge_flag comprises a ppsale_groups.

20. The pay-per-sale ad system in accordance with claim 1, wherein said means for storing one or more ads contained in one or more groups that form the basis of a valid lead as determined by the said correlation logic, wherein the said record contains lead_id, group_id, ad_id, search_time, latency, keywords, campaign_name, product_name, and product_price comprises a ppsale_group_ads.

21. The pay-per-sale ad system in accordance with claim 1, wherein said means for storing one or more ppsale ads as configured by the one or more advertisers in the one or more ads servers, wherein the said record contains dn, se_id, ad_id, product_name, product_price, product_price_after_tax that is computed based on the sales tax rate applicable to the mid, min_product_price_after_tax that is derived based on the product_price_after_tax and a min_threshold_percentage that allows the user to shop for a lower priced product/service than the one the user found in the search results, max_product_price_after_tax that is derived based on the product_price_after_tax and a max_threshold_percentage that allows the user to shop for a higher priced product/service than the one the user found in the search results, and promo_end_time comprises a ppsale_ads.

22. A pay-per-sale ad system for providing proof that the physical store transaction is associated to an online or mobile search and in an anonymous manner, comprising:
an user, for performing one or more online and mobile searches; and making an in-store purchase by swiping a credit card, debit card, or gift card at the card terminal;
an ads server, for creating one or more ppsale advertisers consisting of store name, address, city, state, zip code, directory number (dn), merchant identifier (mid) issued by the processor, sales tax in percentage, and billing details; maintaining a reference data of product catalog consisting of one or more products/services and applicable price ranges in the form of minimum and values; creating and storing one or more ppsale ads comprising a product/service price, one or more keywords associated with one or more campaign names and configured by advertiser; verifying that the product price of each ppsale ad configured is within the allowed minimum and maximum values as specified by the product catalog; sending one or more ppsale advertiser details to one or more card servers; determining the lowest bid amount applicable to one of the groups of ads having the most number of ad ids as reported by lh merchant server;
a search server, for receiving relevant one or more ads from ads server and natural results from the organic listings db; consolidating the paid ads and natural results for presentation to the user; and passing the one or more search results containing one or more ppsale ads info consisting of search time, search type (online or mobile), address for online searches/carrier userid representing the mobile and sent through the wap gateway of the mobile carrier for mobile searches (maybe encrypted), cookie (maybe encrypted), dn, ad id, keywords (maybe encrypted or proxy), and campaign_name (maybe encrypted or proxy) to lh merchant server;
a lh merchant server, for receiving one or more ppsale advertisers information such as se_id, dn, name, address, city, state, zip_code, sales_tax_rate, and mid from one or more ads servers and creating one or more records in the ppsale_advertisers table; sending one or more ppsale advertisers information to one or more card servers; receiving one or more ppsale ads information such as se_id, dn, mid, product_name, product_price, and promo_end_time from one or more ads servers, computing the product_price_after_tax, min_product_price_after_tax, and max_product_price_after_tax values, and creating one or more records in the ppsale_ads table; receiving for the said one or more ppsale ads a final end date of promotion in order to apply automatic extension of the promo_end_time to the said ad_id in the ppsale_ads table from one or more ads servers; receiving one or more search results from the one or more search servers, where each search results contains one or more ppsale ads, and creating one or more records in the search_records table containing the search_record_id, se_id, search_time, ip address for online searches/carrier userid for mobile searches (maybe encrypted), cookie (maybe encrypted), search_type, dn, ad id, keywords (maybe encrypted), and campaign_name (maybe encrypted), provided the dn is present in the ppsale_advertisers table; creating one or more records in the threshold_amounts table based on the product_price_after_tax value of each of the said ad ids received in the search results as well as recursively adding the product_price_after_tax to the threshold_amt in each of the records of the threshold_amounts table, provided the record matching the combination based on the mid, ad_id, threshold_amt, and exp_time does not already exist; sending the one or more records created in the threshold_amounts table to the one or more card servers; creating one or more records in the cards_learned table if either the said ip address/carrier userid or cookie had changed as compared to the existing one or more records in the cards_learned table; creating one or more records in the first_transaction_history table if either the said ip address/carrier userid or cookie had changed as compared to the existing one or more records in the first_transaction_history table; updating the existing one or more records in the first_transaction_history table if the said ip address/carrier userid and cookie had not changed; receiving one or more auth and void transactions from one or more lh tdr servers running at one or more card brands; executing correlation logic to a) determine the se_id on a round-robin basis the search system that could take credit for sending the user to the physical store from one or more search engines; b) create one or more records in the first_transaction_history table for the 1st purchase transaction i.e. auth transaction completed, provided the dn to which the card transaction applies is present in the ppsale_advertisers table and a valid one or more records containing the said dn are present in the search_records table; c) learn a card based on a 2nd purchase transaction from the same card_number as that present in one or more records of the first_transaction_history table and the same ip address/carrier userid and cookie values present in the said records of the first_transaction_history table as that present in one or more records of the search_records table and the said records of the search_records table containing the same dn to which the said purchase transaction is applied; d) match the card_number to one or more records in the cards_learned table containing the same card_number and match the ip address/carrier userid and cookie contained in the said record of the cards_learned table against one or more records of the search_records table containing the same ip address/carrier userid and cookie and match the dn in the said record of the search_records table to which the said subsequent purchase transaction is applied; e) create one or more groups of ads viewed such that the sum of the product prices of the individual products/services, including sales tax, is equal to the minimum amount charged as reported by the card server; f) raise one or more leads for the ads viewed contained in the respective groups to ads server for the 1st and/or 2nd purchase transactions when a card is learned or when one or more subsequent purchase transactions is applied from an already learned card_number based on earliest search_time of one of the said records of the search_records table while ensuring that the number of leads for the dn is less than or equal to the number of ad impressions of various ad_ids and that there is no more than one lead for an impression of the ad by verifying that the search_record_id of the said record of the search_records table is not already present in the leads_raised table; g) create one or more records in the ppsale_charges, ppsale groups, and ppsale group ads tables with the said lead fee received from the ads server; and h) ensure that no lead fee is raised for a void transaction; reporting the said one or more leads to the appropriate lh tdr server running at the concerned card brand; facilitating the viewing of the roi report by one or more authorized employees of the one or more card brands and one or more advertisers; and receiving one or more ppsale advertiser campaign termination notices from one or more ads server and passing the termination notice to one or more card servers, provided the advertiser has terminated the said campaign from the last search engine;
a processor, for capturing and passing one or more card sale transactions data to the card server for authorization by the card issuer; capturing and passing one or more card transactions data to the card server for voiding one or more previous sale transactions by the card issuer;
a lh tdr server, for receiving one or more transactions such as auth and void from the card server, where the message contains transaction_type (auth vs. void), transaction_id, mid (i.e. merchant identifier), card_number (encrypted), last_{—}4, min_amount_charged, and transaction_time; verifying that the mid is present in the ppsale_dns table; creating one or more records in the ppsale_qualifiers table containing the transaction_id, transaction_type, mid, card_number, last_{—}4, min_amount_charged, and transaction_time; forwarding one or more transaction events such as auth and void with the parameters of transaction_id, transaction_type, mid, card_number, last_{—}4, min_amount_charged, and transaction_time to lh merchant server; creating one or more leads in the ppsale_leads table upon receipt of one or more valid leads from the lh merchant server; facilitating the viewing of roi report by one or more authorized employees of the card brand; and purging one or more records in the ppsale_dns table when the advertisers end their ppsale campaigns in one or more ads servers as reported by the card server;
an advertiser, for creating an account in the search system's ads server; creating one or more ppsale campaigns under the account for one or more dns, each containing one or more ad groups, which in turn contains one or more keywords; bidding for one or more keywords; getting charged for one or more valid leads for ads that the user views as part of the search results per the correlation logic; and having the privilege to view the roi report;
a ppsale_advertisers, for storing one or more ppsale advertisers' information that signed up with one or more ads servers;
a search_records, for storing one or more of the ppsale ads viewed by one or more users and received in the search results message from one or more search servers with an expiration_time equal to promo_end_time column value of the ppsale_ads table as determined by the se_id, dn, and and_id combination;
a first_transaction_history, for storing one or more 1st card transactions with an expiration_time equal to the search_time+a predetermined value, provided the dn to which the transaction applies is found in one or more valid records of the search_records table; ensuring that when a 2nd card transaction attempt is received, the said correlation logic makes a determination as to whether or not the transaction is from the same card_number as that present in one or more records of the first_transaction_history table and for a dn present in a valid one or more records of the search_records table and the ip address/carrier userid and cookie values present in the said records of the first_transaction_history table match those in the said records of the search_records table; and updating one or more existing records when a void transaction i.e. set the charge_flag=“n” occurs with transaction_id, card_number and mid matching one or more records present in the first_transaction_history table as well as when new search results are received with ip address/carrier userid and cookie values that match one or more records of the first_transaction_history table;
a cards_learned, for storing one or more cards learned against one or more said ip address/carrier userid and cookie from one or more records of the first_transaction_history and search_records tables per the said correlation logic; updating one or more existing records when new search results are received with ip address/carrier userid and cookie values that match one or more records of the cards_learned table from one or more search servers;
a ppsale_charges, for storing one or more valid leads per the said correlation logic, associated with one or more card_numbers as well as one or more ip address/carrier userid and cookie from one or more records in the search_records table that also contains a do to which the transaction is associated and for which a lead fee based on the lowest bid amount of one of the groups of ads is charged by the ads server;
a ppsale_dns, for storing one or more ppsale advertisers' information that signed up with the one or more ads servers; and verifying that the mid passed from the card server is a valid ppsale advertiser before the lh tdr server processes further the incoming message from the card server;
a ppsale_qualifiers, for storing one or more auth transactions received from the card server, after determining that the mid contained in the message is a valid ppsale advertiser, where the transaction details contain the parameters of transaction_type, transaction_id, min_amt_charged, mid, card_number, last_{—}4, and transaction_time; and maintaining the said auth transactions in the table until such time as the card server reports either a void transaction for the said transaction_id or the lh merchant server reports for the said transaction_id a lead, at which time the said record in the table based on the said transaction_id will be purged;
a ppsale_leads, for storing one or more leads reported by the one or more ads server that in turn were triggered by the said correlation logic; zeroing out the revenue share earned by the card brand for one or more void transactions as reported by the one or more ads servers and triggered by the said correlation logic; and displaying the revenue share earned by the card brand when one or more authorized employees of the card brand view the leads reported by the one or more ads servers;
a leads_raised, for storing one or more leads raised by the said correlation logic so as to ensure that no more than no more than one lead is raised for an impression of the ppsale ad;
a card server, for receiving one or more ppsale advertisers details containing the advertiser name, address, city, state, zip code, mid, and dn from the lh merchant server; forwarding one or more advertiser details, including mid and dn, to the lh tdr server, which in turn will store the values in the ppsale_dns table; receiving and storing one or more threshold amounts from the lh merchant server for the ads viewed by one or more users in the threshold_amounts table; receiving one or more card transactions data relating to auth and void transactions from processor containing, among other parameters, the transaction_type (auth vs. void), card_number, sale_amount, mid, terminal_identifier (tid), and transaction_time; generating a unique transaction_id; determining the closest matching threshold amount for the mid and sale_amount combination and treating the matching threshold_amount as the min_amount_charged to the card before passing it on to the lh tdr server; sending the transaction details consisting of the transaction_type (auth vs. void), transaction_id, mid, card_number (encrypted), last_{—}4, min_amount_charged, and transaction_time to the lh tdr server; purging one or more records in the threshold_amounts table when their expiration_time is reached; purging one or more ppsale advertisers when the advertisers end their ppsale campaigns in one or more ads servers; and receiving the ppsale campaign termination notice from lh merchant server and passing the notice onto the lh tdr server;
a ppsale_groups, for storing one or more groups of ads with a flag that indicates whether or not the group forms the basis of a valid lead as determined by the said correlation logic, wherein the said record contains lead_id, group_id, and charge_flag;
a ppsale_group_ads, for storing one or more ads contained in one or more groups that form the basis of a valid lead as determined by the said correlation logic, wherein the said record contains lead_id, group_id, ad_id, search_time, latency, keywords, campaign_name, product_name, and product_price; and
a ppsale_ads, for storing one or more ppsale ads as configured by the one or more advertisers in the one or more ads servers, wherein the said record contains dn, se_id, ad_id, product_name, product_price, product_price_after_tax that is computed based on the sales tax rate applicable to the mid, min_product_price_after_tax that is derived based on the product_price_after_tax and a min_threshold_percentage that allows the user to shop for a lower priced product/service than the one the user found in the search results, max_product_price_after_tax that is derived based on the product_price_after_tax and a max_threshold percentage that allows the user to shop for a higher priced product/service than the one the user found in the search results, and promo_end_time.

23. A pay-per-sale ad system for providing proof that the physical store transaction is associated to an online or mobile search and in an anonymous manner, comprising:
an user, for performing one or more online and mobile searches; and making an in-store purchase by swiping a credit card, debit card, or gift card at the card terminal;
an ads server, for creating one or more ppsale advertisers consisting of store name, address, city, state, zip code, directory number (dn), merchant identifier (mid) issued by the processor, sales tax in percentage, and billing details; maintaining a reference data of product catalog consisting of one or more products/services and applicable price ranges in the form of minimum and values; creating and storing one or more ppsale ads comprising a product/service price, one or more keywords associated with one or more campaign names and configured by advertiser; verifying that the product price of each ppsale ad configured is within the allowed minimum and maximum values as specified by the product catalog; sending one or more ppsale advertiser details to one or more card servers; determining the lowest bid amount applicable to one of the groups of ads having the most number of ad ids as reported by lh merchant server;
a search server, for receiving relevant one or more ads from ads server and natural results from the organic listings db; consolidating the paid ads and natural results for presentation to the user; and passing the one or more search results containing one or more ppsale ads info consisting of search time, search type (online or mobile), address for online searches/carrier userid representing the mobile and sent through the wap gateway of the mobile carrier for mobile searches (maybe encrypted), cookie (maybe encrypted), dn, ad id, keywords (maybe encrypted or proxy), and campaign_name (maybe encrypted or proxy) to lh merchant server;
a lh merchant server, for receiving one or more ppsale advertisers information such as se_id, dn, name, address, city, state, zip_code, sales_tax_rate, and mid from one or more ads servers and creating one or more records in the ppsale_advertisers table; sending one or more ppsale advertisers information to one or more card servers; receiving one or more ppsale ads information such as se_id, dn, mid, product_name, product_price, and promo_end_time from one or more ads servers, computing the product_price_after_tax, min_product_price_after_tax, and max_product_price_after_tax values, and creating one or more records in the ppsale_ads table; receiving for the said one or more ppsale ads a final end date of promotion in order to apply automatic extension of the promo_end_time to the said ad_id in the ppsale_ads table from one or more ads servers; receiving one or more search results from the one or more search servers, where each search results contains one or more ppsale ads, and creating one or more records in the search_records table containing the search_record_id, se_id, search_time, ip address for online searches/carrier userid for mobile searches (maybe encrypted), cookie (maybe encrypted), search_type, dn, ad id, keywords (maybe encrypted), and campaign_name (maybe encrypted), provided the dn is present in the ppsale_advertisers table; creating one or more records in the threshold_amounts table based on the product_price_after_tax value of each of the said ad ids received in the search results as well as recursively adding the product_price_after_tax to the threshold_amt in each of the records of the threshold_amounts table, provided the record matching the combination based on the mid, ad_id, threshold_amt, and exp_time does not already exist; sending the one or more records created in the threshold_amounts table to the one or more card servers; creating one or more records in the cards_learned table if either the said ip address/carrier userid or cookie had changed as compared to the existing one or more records in the cards_learned table; creating one or more records in the first_transaction_history table if either the said ip address/carrier userid or cookie had changed as compared to the existing one or more records in the first_transaction_history table; updating the existing one or more records in the first_transaction_history table if the said ip address/carrier userid and cookie had not changed; receiving one or more auth and void transactions from one or more lh tdr servers running at one or more card brands; executing correlation logic to a) determine the se_id on a round-robin basis the search system that could take credit for sending the user to the physical store from one or more search engines; b) create one or more records in the first_transaction_history table for the 1st purchase transaction i.e. auth transaction completed, provided the dn to which the card transaction applies is present in the ppsale_advertisers table and a valid one or more records containing the said dn are present in the search_records table; c) learn a card based on a 2nd purchase transaction from the same card_number as that present in one or more records of the first_transaction_history table and the same ip address/carrier userid and cookie values present in the said records of the first_transaction_history table as that present in one or more records of the search_records table and the said records of the search_records table containing the same dn to which the said purchase transaction is applied; d) match the card_number to one or more records in the cards_learned table containing the same card_number and match the ip address/carrier userid and cookie contained in the said record of the cards_learned table against one or more records of the search_records table containing the same ip address/carrier userid and cookie and match the dn in the said record of the search_records table to which the said subsequent purchase transaction is applied; e) create one or more groups of ads viewed such that the sum of the product prices of the individual products/services, including sales tax, is equal to the minimum amount charged as reported by the card server; f) raise one or more leads for the ads viewed contained in the respective groups to ads server for the 1st and/or 2nd purchase transactions when a card is learned or when one or more subsequent purchase transactions is applied from an already learned card_number based on earliest search_time of one of the said records of the search_records table while ensuring that the number of leads for the dn is less than or equal to the number of ad impressions of various ad_ids and that there is no more than one lead for an impression of the ad by verifying that the search_record_id of the said record of the search_records table is not already present in the leads_raised table; g) create one or more records in the ppsale_charges, ppsale groups, and ppsale group ads tables with the said lead fee received from the ads server; and h) ensure that no lead fee is raised for a void transaction; reporting the said one or more leads to the appropriate lh tdr server running at the concerned card brand; facilitating the viewing of the roi report by one or more authorized employees of the one or more card brands and one or more advertisers; and receiving one or more ppsale advertiser campaign termination notices from one or more ads server and passing the termination notice to one or more card servers, provided the advertiser has terminated the said campaign from the last search engine;
a processor, for capturing and passing one or more card sale transactions data to the card server for authorization by the card issuer; capturing and passing one or more card transactions data to the card server for voiding one or more previous sale transactions by the card issuer;
a lh tdr server, for receiving one or more transactions such as auth and void from the card server, where the message contains transaction_type (auth vs. void), transaction_id, mid (i.e. merchant identifier), card_number (encrypted), last_{—}4, min_amount_charged, and transaction_time; verifying that the mid is present in the ppsale_dns table; creating one or more records in the ppsale_qualifiers table containing the transaction_id, transaction_type, mid, card_number, last_{—}4, min_amount_charged, and transaction_time; forwarding one or more transaction events such as auth and void with the parameters of transaction_id, transaction_type, mid, card_number, last_{—}4, min_amount_charged, and transaction_time to lh merchant server; creating one or more leads in the ppsale_leads table upon receipt of one or more valid leads from the lh merchant server; facilitating the viewing of roi report by one or more authorized employees of the card brand; and purging one or more records in the ppsale_dns table when the advertisers end their ppsale campaigns in one or more ads servers as reported by the card server;
an advertiser, for creating an account in the search system's ads server; creating one or more ppsale campaigns under the account for one or more dns, each containing one or more ad groups, which in turn contains one or more keywords; bidding for one or more keywords; getting charged for one or more valid leads for ads that the user views as part of the search results per the correlation logic; and having the privilege to view the roi report;
a ppsale_advertisers, for storing one or more ppsale advertisers' information that signed up with one or more ads servers;
a search_records, for storing one or more of the ppsale ads viewed by one or more users and received in the search results message from one or more search servers with an expiration_time equal to promo_end_time column value of the ppsale ads table as determined by the se_id, dn, and and_id combination;
a first_transaction_history, for storing one or more 1st card transactions with an expiration_time equal to the search_time+a predetermined value, provided the dn to which the transaction applies is found in one or more valid records of the search_records table; ensuring that when a 2nd card transaction attempt is received, the said correlation logic makes a determination as to whether or not the transaction is from the same card_number as that present in one or more records of the first_transaction_history table and for a dn present in a valid one or more records of the search_records table and the ip address/carrier userid and cookie values present in the said records of the first_transaction_history table match those in the said records of the search_records table; and updating one or more existing records when a void transaction i.e. set the charge_flag=“n” occurs with transaction_id, card_number and mid matching one or more records present in the first_transaction_history table as well as when new search results are received with ip address/carrier userid and cookie values that match one or more records of the first_transaction_history table;
a cards_learned, for storing one or more cards learned against one or more said ip address/carrier userid and cookie from one or more records of the first_transaction_history and search_records tables per the said correlation logic; updating one or more existing records when new search results are received with ip address/carrier userid and cookie values that match one or more records of the cards_learned table from one or more search servers;
a ppsale_charges, for storing one or more valid leads per the said correlation logic, associated with one or more card_numbers as well as one or more ip address/carrier userid and cookie from one or more records in the search_records table that also contains a dn to which the transaction is associated and for which a lead fee based on the lowest bid amount of one of the groups of ads is charged by the ads server;
a ppsale_dns, for storing one or more ppsale advertisers' information that signed up with the one or more ads servers; and verifying that the mid passed from the card server is a valid ppsale advertiser before the lh tdr server processes further the incoming message from the card server;
a ppsale_qualifiers, for storing one or more auth transactions received from the card server, after determining that the mid contained in the message is a valid ppsale advertiser, where the transaction details contain the parameters of transaction_type, transaction_id, min_amt_charged, mid, card_number, last_{—}4, and transaction_time; and maintaining the said auth transactions in the table until such time as the card server reports either a void transaction for the said transaction_id or the lh merchant server reports for the said transaction_id a lead, at which time the said record in the table based on the said transaction_id will be purged;
a ppsale_leads, for storing one or more leads reported by the one or more ads server that in turn were triggered by the said correlation logic; zeroing out the revenue share earned by the card brand for one or more void transactions as reported by the one or more ads servers and triggered by the said correlation logic; and displaying the revenue share earned by the card brand when one or more authorized employees of the card brand view the leads reported by the one or more ads servers;
a leads_raised, for storing one or more leads raised by the said correlation logic so as to ensure that no more than no more than one lead is raised for an impression of the ppsale ad;
a card server, for receiving one or more ppsale advertisers details containing the advertiser name, address, city, state, zip code, mid, and do from the lh merchant server; forwarding one or more advertiser details, including mid and dn, to the lh tdr server, which in turn will store the values in the ppsale_dns_table; receiving and storing one or more threshold amounts from the lh merchant server for the ads viewed by one or more users in the threshold_amounts table; receiving one or more card transactions data relating to auth and void transactions from processor containing, among other parameters, the transaction_type (auth vs. void), card_number, sale_amount, mid, terminal_identifier (tid), and transaction_time; generating a unique transaction_id; determining the closest matching threshold amount for the mid and sale_amount combination and treating the matching threshold_amount as the min_amount_charged to the card before passing it on to the lh tdr server; sending the transaction details consisting of the transaction_type (auth vs. void), transaction_id, mid, card_number (encrypted), last_{—}4, min_amount_charged, and transaction_time to the lh tdr server; purging one or more records in the threshold_amounts table when their expiration_time is reached; purging one or more ppsale advertisers when the advertisers end their ppsale campaigns in one or more ads servers; and receiving the ppsale campaign termination notice from lh merchant server and passing the notice onto the lh tdr server;
a ppsale_groups, for storing one or more groups of ads with a flag that indicates whether or not the group forms the basis of a valid lead as determined by the said correlation logic, wherein the said record contains lead_id, group_id, and charge_flag;
a ppsale_group_ads, for storing one or more ads contained in one or more groups that form the basis of a valid lead as determined by the said correlation logic, wherein the said record contains lead_id, group_id, ad_id, search_time, latency, keywords, campaign_name, product_name, and product_price; and
a ppsale_ads, for storing one or more ppsale ads as configured by the one or more advertisers in the one or more ads servers, wherein the said record contains dn, se_id, ad_id, product_name, product_price, product_price_after_tax that is computed based on the sales tax rate applicable to the mid, min_product_price_after_tax that is derived based on the product_price_after_tax and a min_threshold_percentage that allows the user to shop for a lower priced product/service than the one the user found in the search results, max_product_price_after_tax that is derived based on the product_price_after_tax and a max_threshold_percentage that allows the user to shop for a higher priced product/service than the one the user found in the search results, and promo_end_time.
